(19) United States
(12) Patent Application Publication
(10) Pub. No.: US 2024/0380850 A1
(43) Pub. Date: Nov. 14, 2024

(54) IMAGE INSPECTION APPARATUS, IMAGE INSPECTION SYSTEM, IMAGE INSPECTION METHOD, AND NON-TRANSITORY RECORDING MEDIUM

(71) Applicant: Kenta GOTO, Kanagawa (JP)

(72) Inventor: Kenta GOTO, Kanagawa (JP)

(21) Appl. No.: 18/655,358

(22) Filed: May 6, 2024

(30) Foreign Application Priority Data
May 9, 2023 (JP) 2023-077018

(51) Int. Cl. H04N 1/00

(52) U.S. Cl. CPC H04N 1/00087; H04N 1/00005; H04N 1/00015; H04N 1/00037

(57) ABSTRACT

An image inspection apparatus includes circuitry. The circuitry acquires a first image and a second image. The first image is generated by reading, at a first timing, an image formed on a first face of a print medium. The second image is generated by reading, at a second timing later than the first timing, an image formed on a second face of the print medium reversed along a conveyance direction of the print medium. The circuitry receives, for a first inspection area within which the first image is to be inspected, input information relating to a first inspection exclusion area including predetermined processing performed on the print medium. The circuitry sets, based on the received input information, a second inspection exclusion area that is not included in a second inspection area within which the second image is to be inspected.

### CROSS-REFERENCE TO RELATED APPLICATION

This patent application is based on and claims priority pursuant to 35 U.S.C. § 119 (a) to Japanese Patent Application No. 2023-077018, filed on May 9, 2023, in the Japan Patent Office, the entire disclosure of which is hereby incorporated by reference herein.

### BACKGROUND

### Technical Field

Embodiments of the present disclosure relate to an image inspection apparatus, an image inspection system, an image inspection method, and a non-transitory recording medium.

### Related Art

A technique is known that, when a printed matter is subjected to defect detection to determine the quality of the printed matter, adjusts multiple threshold values so as to correspond to the determination criteria as intended by a user.

For example, there is a known image forming apparatus that applies the position and size of an inspection exclusion area set to a front face of a printed matter to a back face of the printed matter in response to the user selecting an “apply to back face” button.

### SUMMARY

According to an embodiment of the present disclosure, an image inspection apparatus includes circuitry. The circuitry acquires a first image and a second image. The first image is generated by reading, at a first timing, an image formed on a first face of a print medium. The second image is generated by reading, at a second timing later than the first timing, an image formed on a second face of the print medium reversed along a conveyance direction of the print medium. The circuitry receives, for a first inspection area within which the first image is to be inspected, input information relating to a first inspection exclusion area including predetermined processing performed on the print medium. The circuitry sets, based on the received input information, a second inspection exclusion area that is not included in a second inspection area within which the second image is to be inspected.

According to an embodiment of the present disclosure, an image inspection system includes an image forming apparatus, and the image inspection apparatus described above. The image forming apparatus includes an image forming engine, image forming device circuitry, and an operation device. The image forming engine forms an image on the print medium based on input image data. The image forming device circuitry performs control to perform the predetermined processing on the print medium. The operation device accepts, for the first inspection area within which the first image formed on the first face is to be inspected, an input of the input information relating to the first inspection exclusion area including the predetermined processing performed on the print medium. The image forming device circuitry transmits the accepted input information to the image inspection apparatus. The image inspection apparatus includes circuitry. The circuitry receives the input information, and sets, based on the received input information, the second inspection exclusion area that is not included in the second inspection area within which the second image formed on the second face is to be inspected.

According to an embodiment of the present disclosure, an image inspection method includes acquiring a first image and a second image. The first image is generated by reading, at a first timing, an image formed on a first face of a print medium. The second image is generated by reading, at a second timing later than the first timing, an image formed on a second face of the print medium reversed along a conveyance direction of the print medium. The image inspection method further includes receiving, for a first inspection area within which the first image is to be inspected, input information relating to a first inspection exclusion area including predetermined processing performed on the print medium, and setting, based on the received input information, a second inspection exclusion area that is not included in a second inspection area within which the second image is to be inspected.

According to an embodiment of the present disclosure, a non-transitory recording medium stores a plurality of instructions which, when executed by one or more processors, causes the processors to perform the above-described image inspection method.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example of an overall configuration of an image management system;

FIG. 2A is a view illustrating an example of the positions of processing on a front face of a print medium;

FIG. 2B is a view illustrating an example of the positions of the processing on a back face of the print medium;

FIG. 3 is a diagram illustrating an example of hardware configurations of an image forming apparatus and an image inspection apparatus;

FIG. 4 is a diagram illustrating an example hardware configuration of a digital front end (DFE) (management server);

FIG. 5 is a diagram illustrating an example functional configuration of the image management system;

FIG. 6 is a conceptual diagram illustrating an example of a job information management table;

FIG. 7 is a conceptual diagram illustrating an example of an inspection exclusion area management table;

FIG. 8 is a sequence diagram illustrating an example of an inspection exclusion area setting process in the image management system;

FIG. 9 is a view illustrating an example of an inspection area setting screen displayed on the image forming apparatus;

FIG. 10 is a view illustrating an example of an inspection area setting screen displayed on the image forming apparatus when setting values are to be applied to the back face;

FIG. 11 is a view illustrating an example of an inspection area setting screen displayed on the image forming apparatus when the setting values are to be applied to at least one of the back face, the print medium, and the entire job.

FIG. 12 is a view illustrating an example of an inspection area setting screen displayed on the image forming apparatus when the setting values are to be applied to the print medium;

FIG. 13 is a view illustrating an example of an inspection area setting screen displayed on the image forming apparatus when the setting values are to be applied to the entire job;

FIG. 14 is a sequence diagram illustrating an example of an image inspection process in the image management system; and

FIG. 15 is a view illustrating an example of an image inspection result notification screen displayed on the image forming apparatus.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure are described below with reference to the accompanying drawings.

### Overall Configuration of Image Management System

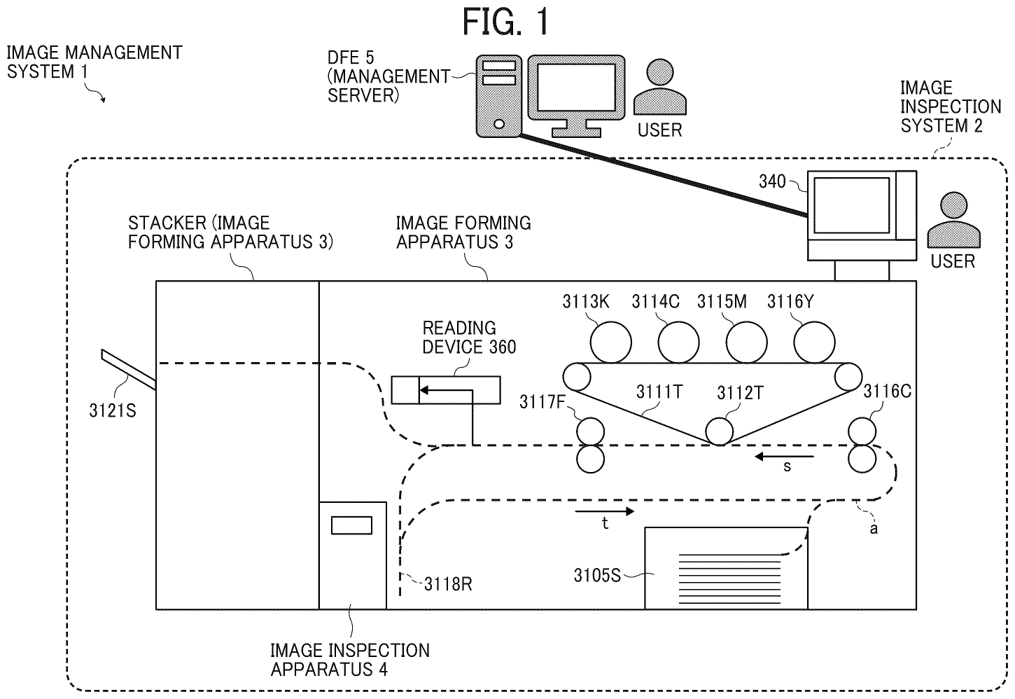

FIG. 1 is a diagram illustrating an example of an overall configuration of an image management system 1. As illustrated in FIG. 1, the image management system 1 includes an image forming apparatus 3, an image inspection apparatus 4, and a digital front end (DFE) 5, which is an example of a management server. The image forming apparatus 3 and the image inspection apparatus 4 in the image management system 1 together operate as an image inspection system 2. In the image management system 1, the image forming apparatus 3 and the DFE 5 are connected to each other via a wired cable. In another example, the image forming apparatus 3 and the DFE 5 may be connected to each other via a communication network through which wireless communication is performed. The communication network herein refers to a communication network through which an unspecified number of communications are performed. Examples of the communication network include, but are not limited to, the Internet, an intranet, and a local area network (LAN). The communication network may also include wireless communication networks such as 4th Generation (4G), 5th Generation (5G), Worldwide Interoperability for Microwave Access (WiMAX), and Long Term Evolution (LTE).

### Image Forming Apparatus

The image forming apparatus 3 forms an image on a print medium based on input image data. The image forming apparatus 3 also performs predetermined processing on the print medium. The image forming apparatus 3 includes a reading device 360, which reads an image formed on the print medium. The image forming apparatus 3 is, for example, a multifunction peripheral/product/printer (MFP) and forms an image on the print medium based on the input made on an operation panel. Specifically, according to various settings that are received from a user through the operation panel, the image forming apparatus 3 forms an image based on a document that has been read or input image data that has been input.

### Image Inspection Apparatus

The image inspection apparatus 4 inspects each of an image formed on a first face of the print medium and an image formed on a second face of the print medium. Specifically, the image inspection apparatus 4 inspects each of the image formed on the first face that has been read by a single device at a first timing and the image formed on the second face that has been read by the single device at a second timing later than the first timing with the print medium reversed along the conveyance direction of the print medium. More specifically, the image inspection apparatus 4 performs the following processes on images formed on the first face and the second face of the print medium. The single device reads the first face of the print medium at the first timing. At the second timing later than the first timing, the single device reads the second face of the print medium reversed along the conveyance direction of the print medium. The image inspection apparatus 4 inspects, at a timing later than the first timing, the image on the first face read at the first timing. The image inspection apparatus 4 inspects, at a timing later than the second timing, the image on the second face read at the second timing. For example, the image inspection apparatus 4 inspects, at a timing later than the second timing, each of the image on the first face read at the first timing and the image on the second face read at the second timing. The term “single device” refers to the reading device 360 included in the image forming apparatus 3. The image inspection apparatus 4 detects (inspects) an abnormal image on the print medium and transmits a predetermined notification to at least one of the image forming apparatus 3 and the DFE 5. Although the image inspection apparatus 4 is built into the image forming apparatus 3 in FIG. 1, the configuration is merely an example and is not limited thereto. For example, the image inspection apparatus 4 and the image forming apparatus 3 may be stand-alone apparatuses connected to each other via a predetermined connection interface (I/F).

### DFE (Management Server)

The DFE 5, which is an example of a management server, is a server that generates an input image for forming an image. The DFE 5, which is one of components included in the image inspection system 2, is implemented by a communication-enabled information processing apparatus (computer system) including a general-purpose office system (OS) installed therein.

In one example, the DFE 5 may be implemented by a single computer such as a general-purpose personal computer (PC), a portable laptop PC, a mobile phone, a smartphone, or a tablet terminal. In another example, the DFE 5 may be implemented by a plurality of computers each of which includes at least one of units for implementing the functions of the DFE 5 including a storage unit, which are divided and respectively assigned to one or more of the computers as appropriate. All or some of the functions of the DFE 5 may be implemented by a server computer residing on a cloud environment or a server computer residing on an on-premise environment. The DFE 5 may be implemented by a communication apparatus or a communication terminal that operates software such as browser software and various applications.

In the present embodiment, when the image inspection system 2 (image inspection apparatus 4) sets inspection exclusion areas for the first face and the second face of the print medium to inspect an image formed on each of the first face and the second face, with the above-described configuration, the image inspection system 2 (image inspection apparatus 4) can set the inspection exclusion areas for the first face and the second face at a time so as to correspond to the position of processing performed on the print medium.

### Terminology

In the present embodiment, the term “print medium” refers to a sheet-like medium having a front face and a back face. Examples of the print medium include, but are not limited to, a sheet of paper (hereinafter referred to as a “sheet”), plastic, and cloth. The first face of the print medium indicates the front face of the print medium. The second face of the print medium indicates the back face of the print medium. Accordingly, the first face and the second face are assumed to be uniquely given regardless of the number of print media (the number of sheets). Specifically, the first face indicates the front face and the second face indicates the back face regardless of whether the number of sheets is one or more. In another example, the first face of the print medium may indicate the back face of the print medium and the second face of the print medium may indicate the front face of the print medium.

In the present embodiment, the “front face” is assumed to be a face assigned an odd-numbered page (e.g., 1, 3, 5, . . . ) when printing, and the “back face” is assumed to be a face assigned an even-numbered page (e.g., 2, 4, 6, . . . ) when printing. In another example, the “front face” may be a face assigned an even-numbered page and the “back face” may be a face assigned an odd-numbered page.

### Internal Configuration of Image Inspection System

An internal configuration of the image inspection system 2 is described below. As illustrated in FIG. 1, the image inspection system 2, which is included in the image management system 1, includes the image forming apparatus 3, the image inspection apparatus 4, which detects, if any, an abnormality (defect) in an image formed on the print medium by the image forming apparatus 3, and a stacker. The stacker functions as part of the image forming apparatus 3, though the stacker may be provided separately from the image forming apparatus 3.

The image forming apparatus 3 includes an operation panel 340, tandem-type, electrophotographic image forming devices 3113K, 3114C, 3115M, and 3116Y, a transfer belt 3111T, a secondary transfer roller 3112T, a sheet feeder 3105S, a conveyance roller pair 3116C, a fixing roller pair 3117F, the reading device 360, and a reversing path 3118R. The operation panel 340 is an operation display on which various operation inputs are performed and various screens are displayed with respect to the image forming apparatus 3.

Each of the image forming devices 3113K, 3114C, 3115M, and 3116Y forms a toner image through an image forming process. The formed toner images are transferred to the transfer belt 3111T one above the other as the transfer belt 3111T is conveyed. Examples of the image forming process include, but are not limited to, a charging process, an exposure process, a development process, a transfer process, and a cleaning process. In the present embodiment, a black toner image is formed by the image forming device 3113K, a cyan toner image is formed by the image forming device 3114C, a magenta toner image is formed by the image forming device 3115M, and a yellow toner image is formed by the image forming device 3116Y. However, the configurations of the image forming devices 3113K, 3114C, 3115M, and 3116Y are not limited to the configurations described above. For example, the order of the arrangement of the image forming devices 3113K, 3114C, 3115M, and 3116Y may be changed as appropriate. The image forming apparatus 3 may also include an image forming device that forms a toner image in color other than black, cyan, magenta, and yellow. The color other than black, cyan, magenta, and yellow may be, for example, white.

After the toner images formed by the image forming devices 3113K, 3114C, 3115M, and 3116Y are superimposed one above the other and transferred onto the transfer belt 3111T to form a full-color toner image, the transfer belt 3111T conveys the full-color toner image to a secondary transfer position at which the secondary transfer roller 3112T transfers the full-color image onto the print medium. In the present embodiment, in a primary transfer process, a yellow toner image is first transferred onto the transfer belt 3111T. Subsequently, a magenta toner image, a cyan toner image, and a black toner image are superimposed and transferred onto the transfer belt 3111T in sequence. However, the order of transfer of the toner images onto the transfer belt 3111T is not limited to the above-described order and may be changed as appropriate. In the following description, when colors are not particularly distinguished from each other, the image forming devices 3113K, 3114C, 3115M, and 3116Y are collectively referred to as “image forming devices 3103.”

The sheet feeder 3105S accommodates a plurality of print media that are stacked on one another, and feeds the print media. Examples of a print medium include, but are not limited to, a recording sheet (transfer sheet). In another example, a print medium may be a coated sheet, cardboard, an overhead projector (OHP) transparency, a plastic film, prepreg, copper foil, or any medium on which an image is formable (printable).

The conveyance roller pair 3116C conveys the print medium fed from the sheet feeder 3105S on a conveyance path a in a direction indicated by an arrow s.

The secondary transfer roller 3112T collectively transfers, at the secondary transfer position, the full-color toner image conveyed by the transfer belt 3111T onto the print medium conveyed by the conveyance roller pair 3116C in a secondary transfer process.

The fixing roller pair 3117F heats and pressurizes the print medium onto which the full-color toner image has been transferred to fix the full-color toner image onto the print medium.

In the case of single-sided printing, the image forming apparatus 3 conveys the print medium onto which the full-color toner image has been fixed to the image inspection apparatus 4. In the case of duplex printing, the image forming apparatus 3 conveys the print medium onto which the full-color toner image has been fixed to the reversing path 3118R.

The reversing path 3118R switches back the conveyed print medium so as to reverse the print medium upside down, and conveys the print medium in a direction indicated by an arrow t. The conveyance roller pair 3116C re-conveys the print medium conveyed by the reversing path 3118R to the secondary transfer roller 3112T. After the secondary transfer roller 3112T transfers the full-color toner image onto the side opposite the previous side, the fixing roller pair 3117F fixes the full-color toner image to the side. Subsequently, the print medium is conveyed to the image inspection apparatus 4 and further to the stacker of the image forming apparatus 3.

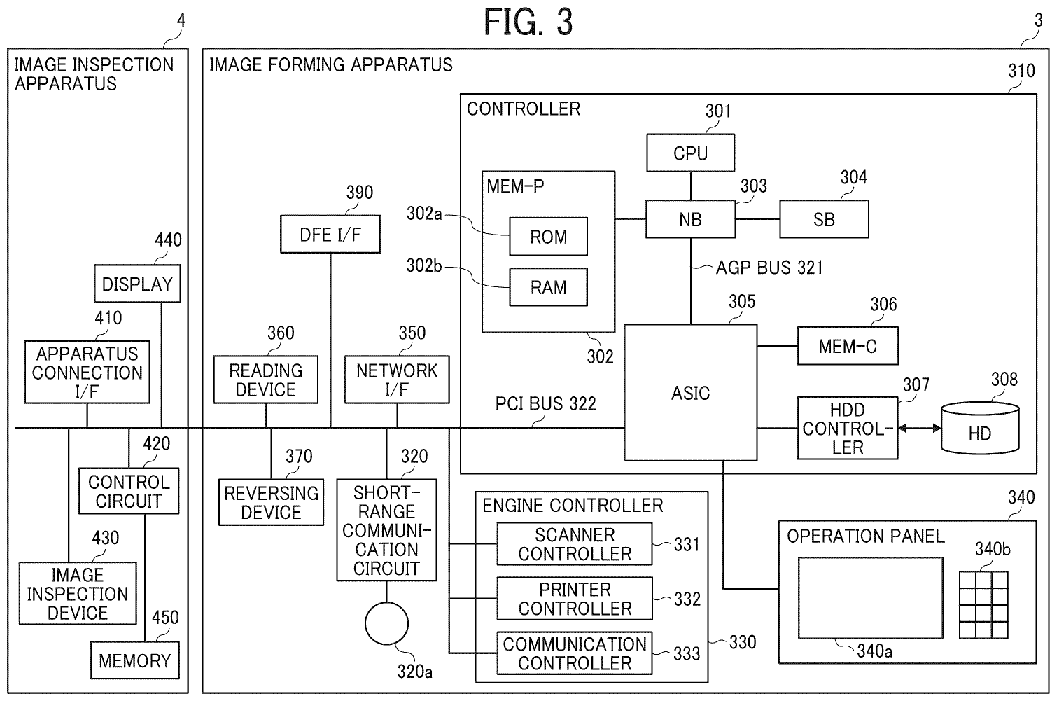

The image inspection apparatus 4 downstream of the image forming apparatus 3 includes, for example, a control circuit 420 and an image inspection device 430, and detects at least one of edge positions of the print medium conveyed from the image forming apparatus 3 and edge positions of an image formed on the print medium. After that, the image inspection apparatus 4 ejects the print medium for which detection has been completed to the stacker of the image forming apparatus 3. A configuration of the image inspection apparatus 4 is described in detail later with reference to FIG. 3.

The stacker includes a tray 3121S. The stacker stacks each print medium ejected from the image inspection apparatus 4 on the tray 3121S.

The reading device 360 is disposed so as to face one side of the print medium and is implemented by, for example, a contact image sensor (CIS). In one example, the reading device 360 includes a mirror, a lens, and a pixel array. In the present embodiment, the number of reading devices 360 is one and the reading device 360 is a single device that operates on one side of the print medium as described above.

The reading device 360 receives light reflecting from the print medium to be read and outputs an image signal. In one example, the reading device 360 outputs an image signal that includes edges (ends) of the print medium conveyed from the image forming apparatus 3 and an image formed on the print medium. The reading device 360 reads the first face (front face) of the print medium at the first timing to read an image formed on the first face (front face), and then reads the second face (back face) of the print medium at the second timing later than the first timing to read an image formed on the second face (back face). The time difference between the first timing and the second timing is due to the time gap between when the reading device 360 reads the first face (front face) and when the reading device 360 reads the second face (back face) after the print medium is switched back and conveyed by the reversing path 3118R. This configuration allows the image inspection apparatus 4 to inspect each of the image formed on the first face that has been read at the first timing and the image formed on the second face that has been read at the second timing later than the first timing. In the present embodiment, the image forming apparatus 3 includes the reading device 360. In another embodiment, the image inspection apparatus 4 may include the reading device 360.

Although the overall internal configuration of the image forming apparatus 3 has been described above, the internal configuration of the image forming apparatus 3 is not limited to the internal configuration described above.

### Positions of Processing on Front Face and Back Face of Print Medium in Relation to Each Other

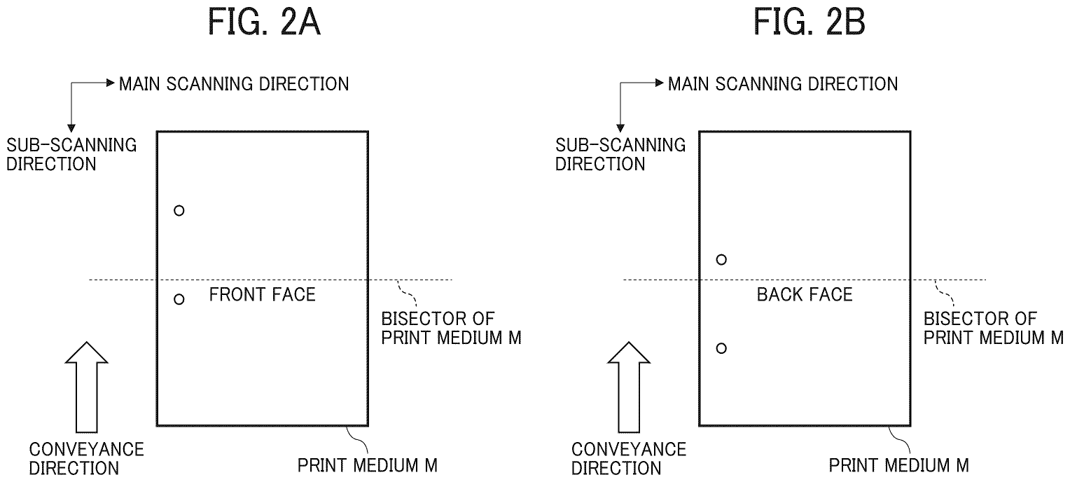

A description is given of positions of processing on the front face and the back face of the print medium in relation to each other. FIGS. 2A and 2B are views illustrating an example of how the processing performed on the print medium M is located on the front face and the back face, respectively. FIG. 2A illustrates the positions of the processing on the front face of the print medium M. In FIG. 2A, a horizontal direction of the print medium M is a main scanning direction, and a vertical direction of the print medium M is a sub-scanning direction (conveyance direction of the print medium M) orthogonal to the main scanning direction. In the example illustrated in FIG. 2A, two holes are formed on a long side of the front face of the print medium M as the processing performed on the print medium M. In this example, the two holes are positioned asymmetrically with respect to a bisector of the print medium M in the conveyance direction of the print medium M.

FIG. 2B illustrates the positions of the processing on the back face of the print medium M. When the print medium M with the two holes formed on the long side of the front face of the print medium M illustrated in FIG. 2A is flipped 180 degrees about the bisector of the print medium M, the two holes viewed from the back face of the print medium M are as illustrated in FIG. 2B. As illustrated in FIG. 2B, the two holes are not positioned symmetrically with respect to the bisector of the print medium M. In this case, the vertical position of each hole on the back face of the print medium M (the position in the conveyance direction) is calculated based on, for example, the size of the print medium M in the conveyance direction and the vertical position coordinates of each hole on the front face of the print medium M. This calculation will be described in detail later.

### Hardware Configurations

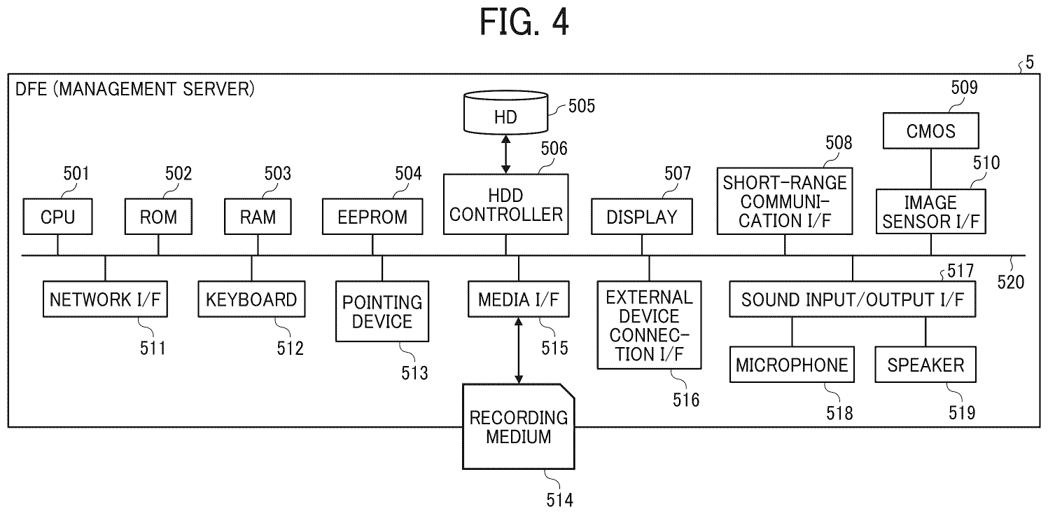

Hardware configurations of the communication terminals or apparatuses included in the image inspection system 2 according to the present embodiment are described below with reference to FIGS. 3 and 4. In the hardware configurations of the apparatuses or communication terminals illustrated in FIGS. 3 and 4, certain components may be added or deleted as appropriate.

Hardware Configurations of Image Forming Apparatus and Image Inspection Apparatus FIG. 3 is a diagram illustrating an example of hardware configurations of the image forming apparatus 3 and the image inspection apparatus 4. As illustrated in FIG. 3, the image forming apparatus 3 is, for example, an MFP and includes hardware resources including a controller 310, a short-range communication circuit 320, an engine controller 330, the operation panel 340, a network I/F 350, the reading device 360, a reversing device 370, and a DFE I/F 390.

The controller 310 includes a central processing unit (CPU) 301, which is a main component of a computer, a system memory (MEM-P) 302, a north bridge (NB) 303, a south bridge (SB) 304, an application specific integrated circuit (ASIC) 305, a local memory (MEM-C) 306, which serves as a storage, a hard disk drive (HDD) controller 307, and a hard disk (HD) 308, which serves as a storage. The NB 303 and the ASIC 305 are connected to each other via an accelerated graphics port (AGP) bus 321.

The CPU 301 is a controller that performs overall control of the image forming apparatus 3. The NB 303 is a bridge that connects the CPU 301 with the MEM-P 302, the SB 304, and the AGP bus 321. The NB 303 includes a memory controller, which controls reading and writing of various data from and to the MEM-P 302, a peripheral component interconnect (PCI) master, and an AGP target.

The MEM-P 302 includes a read-only memory (ROM) 302a and a random-access memory (RAM) 302b. The ROM 302a is a memory that stores a program and data for implementing various functions of the controller 310. The RAM 302b is used as a memory into which programs and data are deployed and also used as a drawing memory that stores drawing data for printing. The programs stored in the RAM 302b may be stored in any computer-readable recording medium, such as a compact-disc read-only memory (CD-ROM), a compact-disc recordable (CD-R), or a digital versatile disc (DVD), in a file format installable or executable by a computer, for distribution.

The SB 304 is a bridge that connects the NB 303 to a PCI device and a peripheral device. The ASIC 305 is an integrated circuit (IC) for image processing applications, which includes hardware components for image processes. The ASIC 305 functions as a bridge that connects the AGP bus 321, a PCI bus 322, the HD 308, and the MEM-C 306 to each other. The ASIC 305 includes a PCI target, an AGP master, an arbiter, a memory controller, a plurality of direct memory access controllers (DMACs), and a PCI device. The arbiter arbitrates the timings at which various signals are driven in the ASIC 305 in accordance with a predetermined priority order. The memory controller controls the MEM-C 306. The plurality of DMACs perform processes such as the rotation of image data with a hardware logic. The PCI device transfers data to and from a scanner controller 331 and a printer controller 332 via the PCI bus 322. The ASIC 305 may be connected to an interface conforming to a standard such as universal serial bus (USB) or institute of electrical and electronics engineers (IEEE) 1394.

The MEM-C 306 is a local memory used as a copy image buffer and a code buffer. The HD 308 is a storage that stores image data, font data for use in printing, and form data. The HDD controller 307 controls writing and reading of data to and from the HD 308 under the control of the CPU 301. The AGP bus 321 is a bus interface for a graphics accelerator card proposed to accelerate graphics processes. The AGP bus 321 enables the graphics accelerator card to directly access the MEM-P 302 with a high throughput, thereby implementing a high-speed graphics accelerator card.

The short-range communication circuit 320 includes a short-range communication antenna 320a. The short-range communication circuit 320 is a communication circuit conforming to a standard such as near field communication (NFC) or Bluetooth™.

The engine controller 330 includes the scanner controller 331, the printer controller 332, and a communication controller 333. The engine controller 330 controls an image forming engine for a scanner and a printer, for example. Specifically, the engine controller 330 controls the scanner via the scanner controller 331. The engine controller 330 controls the printer via the printer controller 332. The operation panel 340 includes a panel display 340a and operation buttons 340b. The panel display 340a is implemented by, for example, a touch panel to display current setting values and a selection screen and accept an input from a user such as an operator. The operation buttons 340b include keys such as numeric keys for accepting the setting values of various conditions relating to image formation such as a density setting condition and a start key for accepting a copy start instruction. In the present embodiment, the panel display 340a functions as an example of display means. The controller 310 controls the entire image forming apparatus 3 to control, for example, drawing, communication, and input from the operation panel 340. At least one of the scanner controller 331 and the printer controller 332 performs various image processes such as error diffusion or gamma (γ) conversion. The communication controller 333 includes, for example, an analog I/F, a modem, and a speaker to perform facsimile communication using an analog line (public line) that connects the communication controller 333 to an external apparatus having a facsimile communication function.

In one example, the operation panel 340 includes an application switching key to allow the user to sequentially switch functions of the image forming apparatus 3 among a document box function, a copy function, a printer function, and a facsimile function. When the user selects the document box function, the image forming apparatus 3 operates in a document box mode. When the user selects the copy function, the image forming apparatus 3 operates in a copy mode. When the user selects the printer function, the image forming apparatus 3 operates in a printer mode. When the user selects the facsimile function, the image forming apparatus 3 operates in a facsimile mode.

The network I/F 350 is an interface for data communication via a wired cable or a communication network. The short-range communication circuit 320 and the network I/F 350 are electrically connected to the ASIC 305 via the PCI bus 322.

The reading device 360 includes hardware resources illustrated in FIG. 1 and includes a circuit and a mechanism for reading an image on the print medium on which the image is formed. The reading device 360 is electrically connected to the ASIC 305 via the PCI bus 322.

The reversing device 370 includes hardware resources equivalent to the reversing path 3118R illustrated in FIG. 1, and includes a circuit and a mechanism for reversing the first face (front face) and the second face (back face) of the print medium on which an image is formed. The reversing device 370 is electrically connected to the ASIC 305 via the PCI bus 322.

The DFE I/F 390 is an interface for connecting the image forming apparatus 3 to the DFE 5.

The short-range communication circuit 320, the network I/F 350, the reading device 360, the reversing device 370, and the DFE I/F 390 described above are connected to each of an apparatus connection I/F 410 and the image inspection device 430 of the image inspection apparatus 4 to be described later via the PCI bus 322, which is connected to the ASIC 305. As illustrated in FIG. 3, the image inspection apparatus 4 is, for example, a computer and includes hardware resources including the apparatus connection I/F 410, the control circuit 420, the image inspection device 430, a display 440, and a memory 450. The apparatus connection I/F 410 is an interface for connecting the image inspection apparatus 4 to the image forming apparatus 3. In the present embodiment, the apparatus connection I/F 410 is, for example, a PCI I/F.

The control circuit 420 is a circuit that controls the entire image inspection apparatus 4. The control circuit 420 includes hardware resources including a CPU, an ASIC, and an HDD controller. The control circuit 420 may be implemented as a single chip with an integrated circuit such as the ASIC described above.

The image inspection device 430 is a device that inspects an image formed on the print medium in cooperation with the control circuit 420, and is implemented by, for example, a CPU. In one example, the image inspection device 430 compares the image formed on the print medium with an image such as a predetermined reference image stored in the memory 450, and determines whether the image formed on the print medium is normal or abnormal based on a predetermined threshold value, for example.

The display 440 displays various pieces of information such as a cursor, menus, windows, characters, and images. In the present embodiment, the display 440 functions as an example of display means.

The memory 450 includes storage media including a ROM, a RAM, an electrically erasable programmable read-only memory (EEPROM), and an HD. In the present embodiment, the memory 450 includes at least one of the storage media described above.

In the present embodiment, the image inspection apparatus 4 uses a storage unit 3000 of the image forming apparatus 3 in a shared manner with the image forming apparatus 3 and exchanges, for example, information (data) relating to various processes, control information (data) for controlling the hardware configuration of the image inspection apparatus 4, and image data via the PCI bus 322.

In another embodiment, the image inspection apparatus 4 may independently include the above-described hardware resources included in the image forming apparatus 3. When the image inspection apparatus 4 includes various hardware resources such as the CPU independently of the image forming apparatus 3, the image inspection apparatus 4 may, for example, exchange information (data) relating to processes being performed or to be performed in cooperation with the image forming apparatus 3, instead of exchanging all data via the PCI bus 322.

### Hardware Configuration of DFE

FIG. 4 is a diagram illustrating an example hardware configuration of the DFE (management server) 5. As illustrated in FIG. 4, the DFE 5 is, for example, implemented by a computer, and includes a CPU 501, a ROM 502, a RAM 503, an EEPROM 504, an HD 505, an HDD controller 506, a display 507, a short-range communication I/F 508, a complementary metal oxide semiconductor (CMOS) sensor 509, and an image sensor I/F 510. The DFE 5 further includes a network I/F 511, a keyboard 512, a pointing device 513, a media I/F 515, an external device connection I/F 516, a sound input/output I/F 517, a microphone 518, a speaker 519, and a bus line 520.

The CPU 501 controls the entire operation of the DFE 5. The ROM 502 stores, for example, a program for executing the CPU 501. The RAM 503 is used as a work area for the CPU 501. The EEPROM 504 reads and writes various data of, for example, an application under the control of the CPU 501. The display 507 displays various pieces of information such as a cursor, menus, windows, characters, and images. In the present embodiment, the display 507 functions as an example of display means. The short-range communication I/F 508 is a communication circuit for performing data communication with, for example, a communication apparatus or a communication terminal including a wireless communication interface conforming to a standard such as NFC, Bluetooth™, or Wireless Fidelity (Wi-Fi™). The CMOS sensor 509 is an example of built-in imaging means that captures an image of a subject under the control of the CPU 501 to obtain image data or video data. The imaging means may be imaging means including a charge coupled device (CCD) sensor, instead of the CMOS sensor. The image sensor I/F 510 is a circuit that controls driving of the CMOS sensor 509.

The network I/F 511 is an interface for performing data communication via a wired cable or a wireless communication network. The keyboard 512 is an example of input means including a plurality of keys for inputting characters, numerical values, and various instructions. The DFE 5 may include input means such as a touch panel, instead of or in addition to the keyboard 512. The pointing device 513 is an example of input means that allows the user to select or execute various instructions, select an object to be processed, and move a cursor being displayed. The media I/F 515 controls reading and writing (storing) of data from and to a recording medium 514 such as a flash memory. The external device connection I/F 516 is an interface for connecting the DFE 5 to various external devices. Examples of the external devices include, but are not limited to, a USB memory. The sound input/output I/F 517 is a circuit for controlling input and output of a sound signal between the microphone 518 and the speaker 519 under the control of the CPU 501. The microphone 518 includes a built-in circuit that converts sound into an electric signal. The microphone 518 acquires sound or sound waves emitted from, for example, an external speaker, and acquires information using an electric signal. The speaker 519 is a built-in circuit that converts an electric signal into physical vibration to generate sound such as music or voice. The bus line 520 is, for example, an address bus or a data bus that electrically connects the components such as the CPU 501 to each other.

In one example, any one of the above-described programs may be recorded in a file in a format installable or executable on a computer-readable recording medium or may be downloaded through a network for distribution. Examples of the recording medium include, but are not limited to, a CD-R, a DVD, a Blu-ray™ disc, a secure digital (SD) card, and a USB memory. Such a recording medium may be, for example, provided in domestic markets or foreign markets as program products. For example, the image inspection apparatus 4 executes a program according to an embodiment of the present disclosure to implement an image inspection method according to an embodiment of the present disclosure.

### Functional Configuration of Image Management System

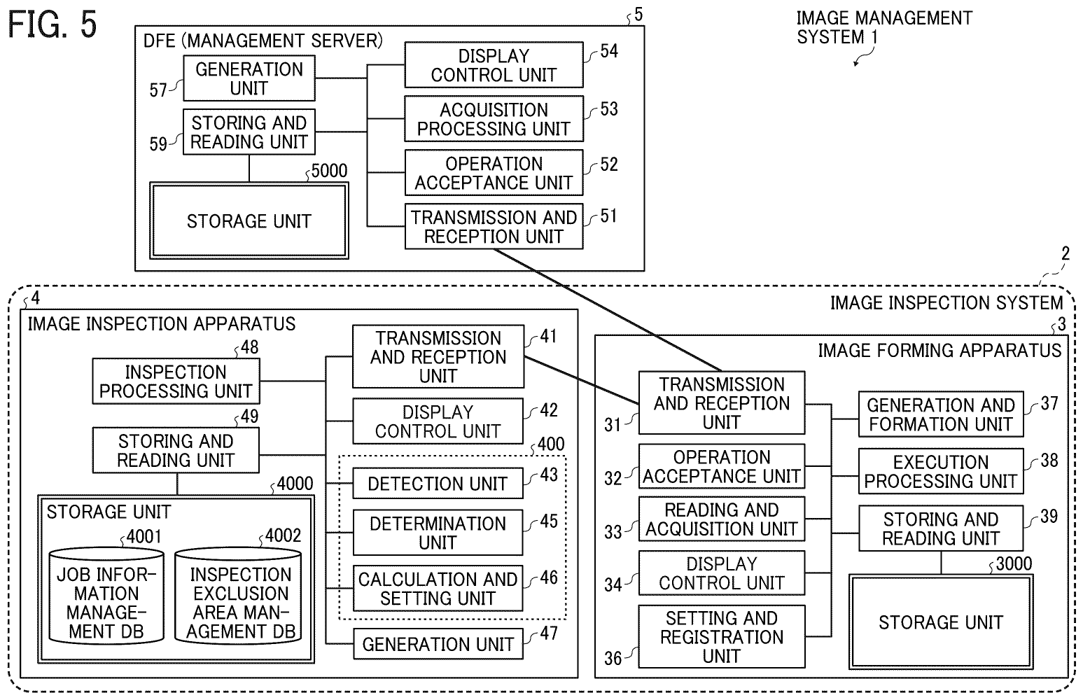

A functional configuration of the image management system 1 according to the present embodiment is described with reference to FIGS. 5 to 7. FIG. 5 is a diagram illustrating an example functional configuration of the image management system 1. FIG. 5 illustrates apparatuses relating to processes or operations described later among the apparatuses illustrated in FIG. 1.

### Functional Configuration of Image Forming Apparatus

A functional configuration of the image forming apparatus 3 is described with reference to FIG. 5. As illustrated in FIG. 5, the image forming apparatus 3 includes a transmission and reception unit 31, an operation acceptance unit 32, a reading and acquisition unit 33, a display control unit 34, a setting and registration unit 36, a generation and formation unit 37, an execution processing unit 38, and a storing and reading unit 39. Each of these functional units of the image forming apparatus 3 is a function or means implemented by one or more of the hardware resources illustrated in FIG. 3 operating in accordance with instructions from the CPU 301 according to a program for the image forming apparatus 3 deployed in the RAM 302b from at least one of the ROM 302a and the HD 308. The image forming apparatus 3 also includes the storage unit 3000, which is implemented by at least one of the ROM 302a and the HD 308 illustrated in FIG. 3. The storage unit 3000 stores, for example, a communication program (communication application) and a browser application, which are used to perform communication with the DFE 5 and the image inspection apparatus 4 via a wired cable or a communication network. As described above, the image forming apparatus 3 may be connected to the image inspection apparatus 4 via the internal bus. In this case, when performing communication with the image inspection apparatus 4, the image forming apparatus 3 does not use the communication program described above.

### Each Functional Configuration of Image Forming Apparatus

Each functional configuration of the image forming apparatus 3 is described in detail below. The transmission and reception unit 31 of the image forming apparatus 3 illustrated in FIG. 5 is mainly implemented by processes performed by the CPU 301 on the network I/F 350, and transmits and receives various data (or information) to and from the DFE 5 via a wired cable or a communication network. The transmission and reception unit 31 also transmits and receives various data (or information) and image data to and from the image inspection apparatus 4 via the PCI bus 322. The transmission and reception unit 31 also transmits input information accepted by the operation acceptance unit 32 to the image inspection apparatus 4. In the present embodiment, the transmission and reception unit 31 functions as an example of at least one of first transmission means and second reception means. In the present embodiment, the input information includes inspection exclusion area information input into the image forming apparatus 3.

The operation acceptance unit 32 is mainly implemented by the CPU 301 processing signals generated through various operations accepted by the panel display 340a of the operation panel 340. The operation acceptance unit 32 accepts various condition settings input by the user into the panel display 340a or input by the user using at least one of the operation buttons 340b of the operation panel 340. The operation acceptance unit 32 also accepts, for a first inspection area within which a first image formed on the first face of the print medium is to be inspected, the input of input information relating to a first inspection exclusion area including predetermined processing performed on the print medium. In the present embodiment, the operation acceptance unit 32 functions as an example of acceptance means.

The reading and acquisition unit 33 is mainly implemented by processes performed by the CPU 301 on the scanner controller 331 and the reading device 360, and reads and acquires an image of a document set on the image forming apparatus 3. The reading and acquisition unit 33 also reads and acquires an image formed on the first face (front face) and an image formed on the second face (back face) of the print medium on which predetermined processing has been performed. In the present embodiment, the reading and acquisition unit 33 functions as an example of reading means and an example of acquisition means.

The display control unit 34 is mainly implemented by processes performed by the CPU 301 on the operation panel 340, and controls the display of various screens and information (data) in the image forming apparatus 3. For example, the display control unit 34 uses a browser to display a display screen generated in, for example, hyper text markup language (HTML) on the operation panel 340. In the present embodiment, the display control unit 34 functions as an example of display control means.

The setting and registration unit 36 is mainly implemented by processes performed by the CPU 301 and performs various settings relating to, for example, the type of print medium. In the present embodiment, the setting and registration unit 36 functions as an example of setting means and an example of registration means.

The generation and formation unit 37 is mainly implemented by processes performed by the CPU 301 on the printer controller 332. The generation and formation unit 37 generates image data for printing based on the input image data or read document and forms an image on the print medium. In the present embodiment, the generation and formation unit 37 functions as an example of generation means and an example of formation means.

The execution processing unit 38 is mainly implemented by processes performed by the CPU 301. The execution processing unit 38 executes a generation process and a formation process performed by the generation and formation unit 37 and also performs various processes. In the present embodiment, the execution processing unit 38 functions as an example of execution means.

The storing and reading unit 39 is mainly implemented by processes performed by the CPU 301 on the ROM 302a and the HD 308. The storing and reading unit 39 stores various data (or information) in the storage unit 3000 and reads various data (or information) from the storage unit 3000. In the present embodiment, the storing and reading unit 39 functions as an example of storing and reading means.

### Functional Configuration of Image Inspection Apparatus

A functional configuration of the image inspection apparatus 4 is described below. As illustrated in FIG. 5, the image inspection apparatus 4 includes a transmission and reception unit 41, a display control unit 42, a detection unit 43, a determination unit 45, a calculation and setting unit 46, a generation unit 47, an inspection processing unit 48, and a storing and reading unit 49. The image inspection apparatus 4 also includes an image comparison and inspection unit 400, which includes the detection unit 43, the determination unit 45, and the calculation and setting unit 46. Each of these functional units is a function or means implemented by one or more of the hardware resources illustrated in FIG. 3 operating in accordance with instructions from the CPU 301 according to a program for the image inspection apparatus 4 deployed in the RAM 302b from at least one of the ROM 302a and the HD 308 of the image forming apparatus 3. The image inspection apparatus 4 also includes a storage unit 4000, which is implemented by the memory 450. The storage unit 4000 may store, for example, a communication program (communication application) and a browser application, which are used to perform communication with the image forming apparatus 3 via the PCI bus 322 or may have an execution area where a communication protocol using the PCI bus 322 is executed.

In the present embodiment, the image inspection apparatus 4 may use the storage unit 3000 of the image forming apparatus 3 in a shared manner with the image forming apparatus 3. For example, the image inspection apparatus 4 may use the communication program (communication application) and the browser application stored in the storage unit 3000 of the image forming apparatus 3 in a shared manner with the image forming apparatus 3. However, the present embodiment is not limited to this configuration as long as the image inspection apparatus 4 independently includes, for example, the CPU and the ASIC included in the control circuit 420. In this case, the image inspection apparatus 4 may independently include the storage unit 4000 as described above.

### Each Functional Configuration of Image Inspection Apparatus

Each functional configuration of the image inspection apparatus 4 is described in detail below. The transmission and reception unit 41 of the image inspection apparatus 4 illustrated in FIG. 5 is mainly implemented by processes performed by the control circuit 420 on the apparatus connection I/F 410, and transmits and receives various data (or information) to and from the image forming apparatus 3 via the apparatus connection I/F 410, which is connected to the PCI bus 322. The transmission and reception unit 41 also receives, for a first inspection area within which a first image formed on the first face of the print medium is to be inspected, the input information relating to the first inspection exclusion area including predetermined processing performed on the print medium. The transmission and reception unit 41 also receives, as the input information relating to the first inspection exclusion area, a width of the first inspection exclusion area including the predetermined processing performed on the print medium and a plurality of coordinates indicating the width. In the present embodiment, the transmission and reception unit 41 functions as an example of at least one of second transmission means and first reception means.

The display control unit 42 is mainly implemented by processes performed by the control circuit 420 on the display 440, and displays, on the display 440, a screen including various pieces of information in the image inspection apparatus 4. In the present embodiment, the display control unit 42 functions as an example of display control means.

The detection unit 43 is mainly implemented by processes performed by the control circuit 420 on the image inspection device 430, and inspects an image formed on the print medium to detect, if any, an abnormality, for example. In the present embodiment, the detection unit 43 functions as an example of detection means.

The determination unit 45 is mainly implemented by processes performed by the control circuit 420, and performs various determinations in the image inspection apparatus 4. In the present embodiment, the determination unit 45 functions as an example of determination means.

The calculation and setting unit 46 is mainly implemented by processes performed by the control circuit 420, and sets a second inspection exclusion area based on the input information transmitted from the image forming apparatus 3. The second inspection exclusion area refers to an area that is not included in a second inspection area within which a second image formed on the second face of the print medium is to be inspected. The calculation and setting unit 46 also sets the second inspection exclusion area based on the input information and length information, which indicates the length of the print medium along the conveyance direction of the print medium. The calculation and setting unit 46 also sets the second inspection exclusion area to at least one of the print medium and the entire predetermined job forming the print medium in response to an operation of collectively setting the second inspection exclusion area. The calculation and setting unit 46 performs settings on various data tables managed in the image inspection apparatus 4. In the present embodiment, the calculation and setting unit 46 functions as an example of calculation means and an example of setting means.

In the present embodiment, the image comparison and inspection unit 400, which includes the detection unit 43, the determination unit 45, and the calculation and setting unit 46, functions as image comparison and inspection means that comprehensively inspects and compares images.

The generation unit 47 is mainly implemented by processes performed by the control circuit 420, and generates a master image based on a raster image processor (RIP) image expressed by cyan, magenta, yellow, and black (CMYK) transmitted from the image forming apparatus 3. When an abnormal image is detected, the generation unit 47 also generates notification data to notify the image forming apparatus 3 of the abnormality. In the present embodiment, the generation unit 47 functions as an example of generation means.

The inspection processing unit 48 is mainly implemented by processes performed by the control circuit 420 on the image inspection device 430, and inspects the first image and the second image formed on the print medium. In the present embodiment, the inspection processing unit 48 functions as an example of inspection means.

The storing and reading unit 49 is mainly implemented by processes performed by the control circuit 420 on the memory 450. The storing and reading unit 49 stores various data (or information) in the storage unit 4000 and reads various data (or information) from the storage unit 4000. In the present embodiment, the storing and reading unit 49 functions as an example of storing and reading means.

### Job Information Management Table

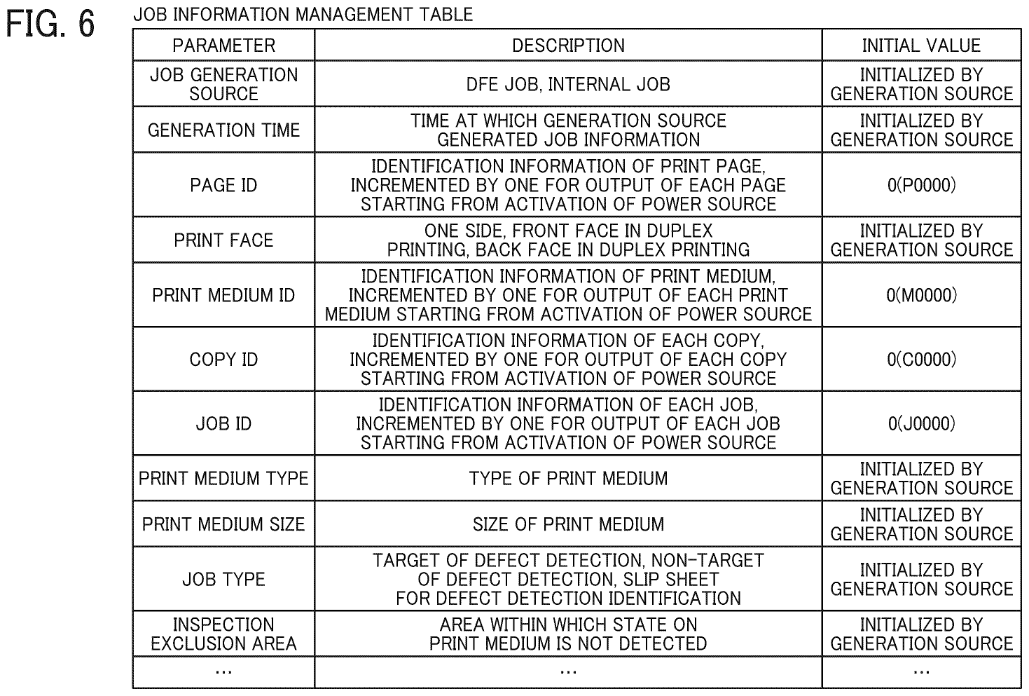

FIG. 6 is a conceptual diagram illustrating an example of a job information management table. The data table described below is merely an example and is not limited thereto. The storage unit 4000 stores a job information management database (DB) 4001, which includes the job information management table illustrated in FIG. 6. The job information management table stores and manages each parameter in association with a description and an initial value to centrally manage various pieces of information relating to various jobs executed by the image forming apparatus 3.

Referring now to FIG. 6, the “parameter” indicates a parameter relating to each job executed by the image forming apparatus 3. Examples of the parameter include, but are not limited to, “job generation source,” “generation time,” “page ID,” “print side,” “print medium ID,” “copy ID,” “job ID,” “print medium type,” “print medium size,” “job type,” and “inspection exclusion area.” The “description” provides, for example, a specific example of each parameter described above. The “initial value” indicates an initial value given to each parameter. The “initial value” is, for example, a predetermined value or set by a job generation source.

In the present embodiment, the job information management table (job information management DB 4001) functions as an example of job information management means.

### Inspection Exclusion Area Management Table

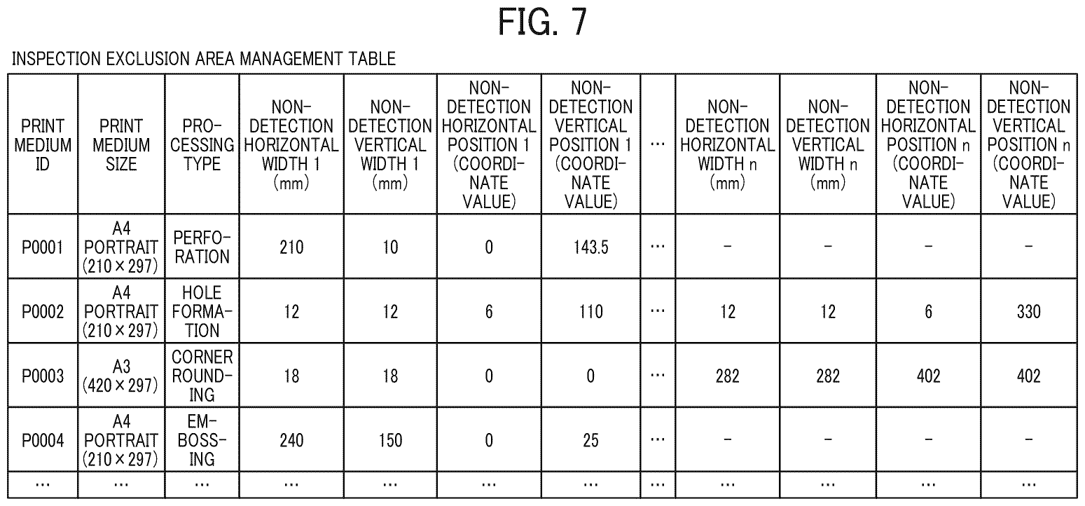

FIG. 7 is a conceptual diagram illustrating an example of an inspection exclusion area management table. The data table described below is merely an example and is not limited thereto. The storage unit 4000 stores an inspection exclusion area management DB 4002, which includes the inspection exclusion area management table illustrated in FIG. 7. The inspection exclusion area management table stores and manages each print medium ID in association with items “print medium size,” “processing type,” “non-detection horizontal width 1,” “non-detection vertical width 1,” “non-detection horizontal position 1,” “non-detection vertical position 1,” “non-detection horizontal width n,” “non-detection vertical width n,” “non-detection horizontal position n,” and “non-detection vertical position n.” The term “non-detection” referred to in the items managed by the inspection exclusion area management DB 4002 has the same meaning as the term “inspection exclusion.”

Referring now to FIG. 7, the “processing type” indicates the type of processing performed on the print medium M. Examples of the “processing type” include, but are not limited to, “perforation,” “hole formation,” “corner rounding,” and “embossing.” The item “non-detection horizontal width 1” indicates a value of the width of an inspection exclusion area in the main scanning direction. The inspection exclusion area includes predetermined processing performed on the print medium M. The item “non-detection vertical width 1” indicates a value of the width of the inspection exclusion area in the sub-scanning direction. The item “non-detection horizontal position 1” indicates a coordinate value of the inspection exclusion area in the main scanning direction on the print medium M. The item “non-detection vertical position 1” indicates a coordinate value of the inspection exclusion area in the sub-scanning direction on the print medium M. When there are two or more inspection exclusion areas, the setting values of the horizontal and vertical widths and positions of an n-th inspection exclusion area (n=natural number greater than 1) including the predetermined processing performed on the print medium M are, for example, described and managed in the items indicated by a suffix n. The item “non-detection horizontal width n” indicates a value of the width of the n-th inspection exclusion area in the main scanning direction. The item “non-detection vertical width n” indicates a value of the width of the n-th inspection exclusion area in the sub-scanning direction. The item “non-detection horizontal position n” indicates a coordinate value of the n-th inspection exclusion area in the main scanning direction on the print medium M. The item “non-detection vertical position n” indicates a coordinate value of the n-th inspection exclusion area in the sub-scanning direction on the print medium M.

In the example illustrated in FIG. 7, for convenience of description, in the case of the processing type “hole formation” where two holes are formed on the print medium M, the setting values of the horizontal and vertical widths and positions of the inspection exclusion area within which the second hole is formed are described in the items indicated by the suffix n. However, the present disclosure is not limited to this example, and the setting values of the horizontal and vertical widths and positions may be described and managed in the respective items indicated by a suffix 2 (n=2). Similarly, in the case of the processing type “corner rounding” where four corners of the print medium M having a rectangular shape are rounded, the setting values of the horizontal and vertical widths and positions of the inspection exclusion area within which the fourth rounded corner is formed may be described and managed in the respective items indicated by a suffix 4 (n=4).

In the present embodiment, the inspection exclusion area management table (inspection exclusion area management DB 4002) functions as an example of inspection exclusion area management means.

### Functional Configuration of DFE (Management Server)

Referring back to FIG. 5, a functional configuration of the DFE 5 is described below. As illustrated in FIG. 5, the DFE 5 includes a transmission and reception unit 51, an operation acceptance unit 52, an acquisition processing unit 53, a display control unit 54, a generation unit 57, and a storing and reading unit 59. Each of these functional units of the DFE 5 is a function or means implemented by one or more of the hardware resources illustrated in FIG. 4 operating in accordance with instructions from the CPU 501 according to a program for the DFE 5 deployed in the RAM 503 from at least one of the ROM 502, the EEPROM 504, the HD 505, and the recording medium 514. The DFE 5 also includes a storage unit 5000, which is implemented by at least one of the ROM 502, the EEPROM 504, the HD 505, and the recording medium 514 illustrated in FIG. 4. The storage unit 5000 stores, for example, a communication program (communication application) and a browser application, which are used to perform communication with the image forming apparatus 3.

### Each Functional Configuration of DFE (Management Server)

Each functional configuration of the DFE 5 is described in detail below. The transmission and reception unit 51 of the DFE 5 illustrated in FIG. 5 is mainly implemented by processes performed by the CPU 501 on the network I/F 511 and the short-range communication I/F 508, and transmits and receives various data (or information) to and from the image forming apparatus 3 via, for example, a wired cable. In the present embodiment, the transmission and reception unit 51 functions as an example of at least one of transmission means and reception means. The DFE 5 may perform wireless communication with the image forming apparatus 3 via a predetermined wireless communication network.

The operation acceptance unit 52 is mainly implemented by the CPU 501 processing signals generated through various operations accepted by at least one of the keyboard 512 and the pointing device 513. The operation acceptance unit 52 accepts various condition settings input by the user to at least one of the keyboard 512 and the pointing device 513. The operation acceptance unit 52 may be implemented by the CPU 501 processing signals generated through various operations accepted by input means such as a touch panel, instead of or in addition to the keyboard 512 and the pointing device 513. In the present embodiment, the operation acceptance unit 52 functions as an example of acceptance means.

The acquisition processing unit 53 is mainly implemented by processes performed by the CPU 501, and acquires, for example, a setting request transmitted from the image forming apparatus 3. In the present embodiment, the acquisition processing unit 53 functions as an example of acquisition processing means.

The display control unit 54 is mainly implemented by processes performed by the CPU 501 on the display 507, and controls the display of various screens and information (data) in the DFE 5. For example, the display control unit 54 may use a browser to display a display screen generated in, for example, HTML on the display 507. In the present embodiment, the display control unit 54 functions as an example of display control means.

The generation unit 57 is mainly implemented by processes performed by the CPU 501, and generates job data to be executed by the image forming apparatus 3. In the present embodiment, the generation unit 57 functions as an example of generating means.

The storing and reading unit 59 is mainly implemented by processes performed by the CPU 501 on at least one of the ROM 502, the EEPROM 504, the HD 505, and the recording medium 514. The storing and reading unit 59 stores various data (or information) in the storage unit 5000 and reads various data (or information) from the storage unit 5000. In the present embodiment, the storing and reading unit 59 functions as an example of storing and reading means.

### Processes and Operations According to Embodiment

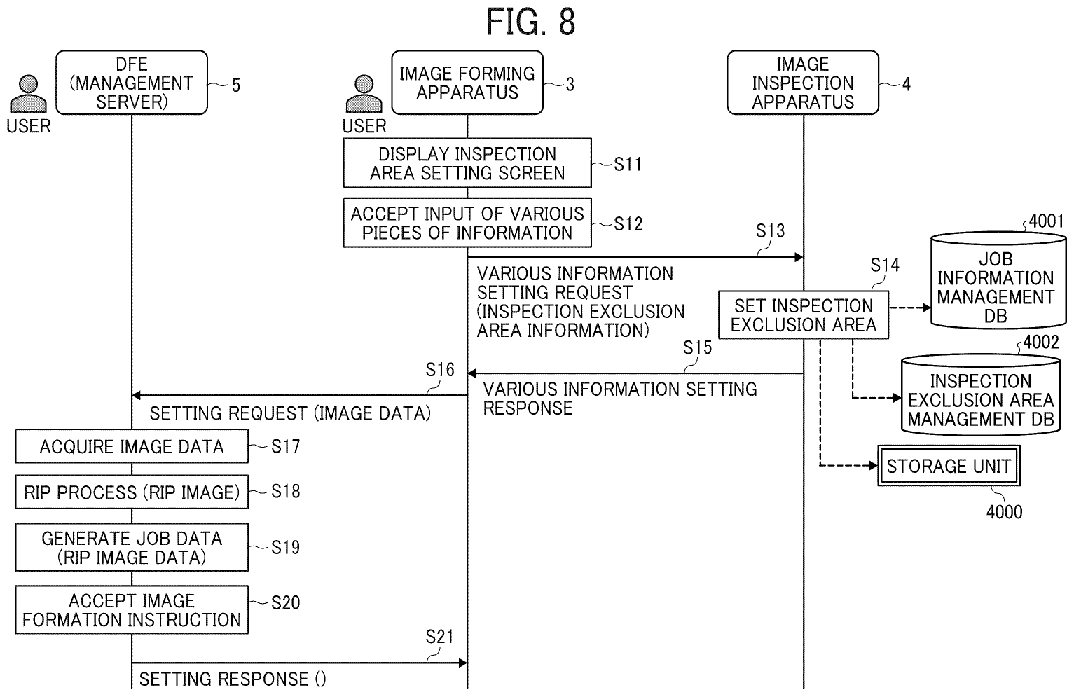

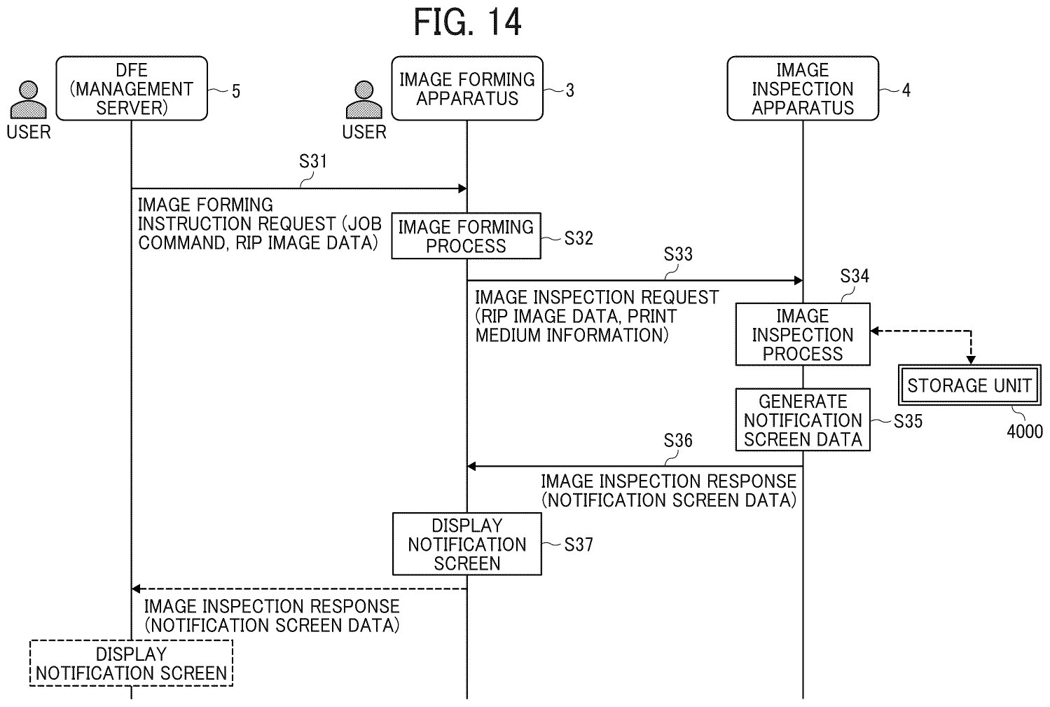

Processes and operations of the image inspection system 2 according to the present embodiment are described below with reference to FIGS. 8 to 15. The sequence diagrams illustrated in FIGS. 8 and 14 are merely an example and are not limited thereto.

### Inspection Exclusion Area Setting Process

An inspection exclusion area setting process is described below. FIG. 8 is a sequence diagram illustrating an example of the inspection exclusion area setting process in the image management system 1. As illustrated in FIG. 8, in step S11, the display control unit 34 of the image forming apparatus 3 displays an inspection area setting screen. Specifically, the display control unit 34 displays an inspection area setting screen described later on the panel display 340a of the operation panel 340.

### Example of Screen Display

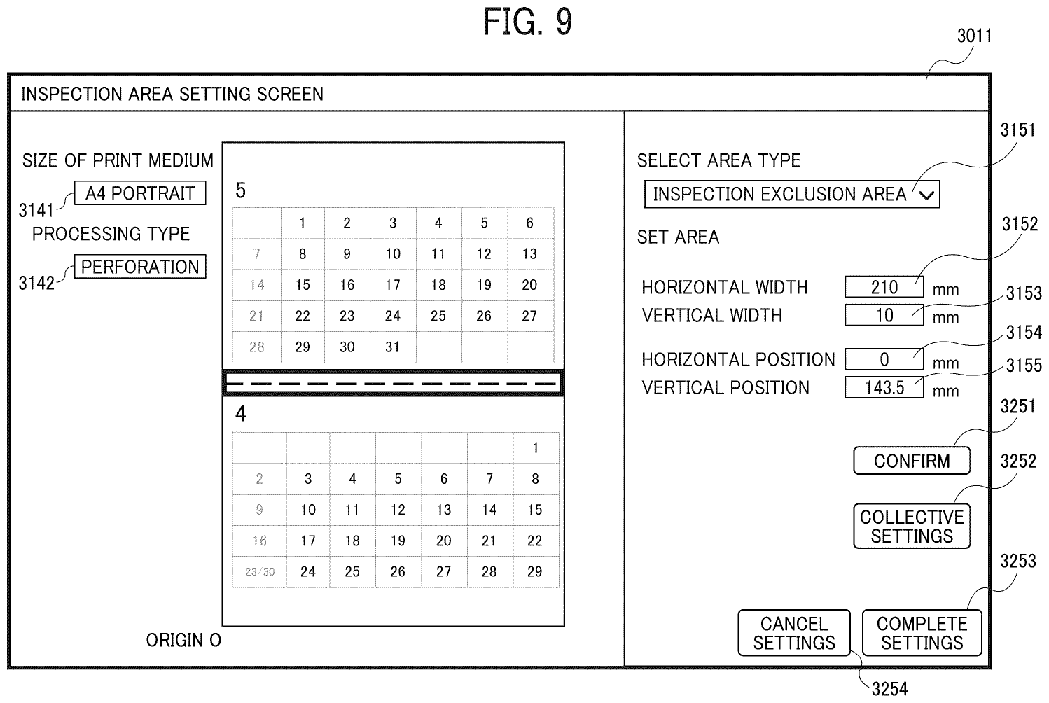

FIG. 9 is a view illustrating an example of the inspection area setting screen displayed on the image forming apparatus 3. The display control unit 34 displays an inspection area setting screen 3011 on the panel display 340a of the operation panel 340 of the image forming apparatus 3. The inspection area setting screen 3011 displays an image formed on the print medium to be inspected (in this example, a thumbnail image on the front face), a print medium size input field 3141, a processing type input field 3142, an area type selection region 3151, a horizontal width setting region 3152, a vertical width setting region 3153, a horizontal position setting region 3154, a vertical position setting region 3155, a “confirm” button 3251, a “collective settings” button 3252, a “complete settings” button 3253, and a “cancel settings” button 3254. The horizontal width setting region 3152, the vertical width setting region 3153, the horizontal position setting region 3154, and the vertical position setting region 3155 relate to area settings.

The area type selection region 3151 allows the user to select an area from a list of areas including the “inspection exclusion area” that appears in response to the user operating a pull-down key. Each of the horizontal width setting region 3152, the vertical width setting region 3153, the horizontal position setting region 3154, and the vertical position setting region 3155 relating to the area settings accepts an input of a desired value from the user. In one example, the user determines desired values of the horizontal position and the vertical position based on an origin O of the thumbnail image and inputs the desired values to the horizontal position setting region 3154 and the vertical position setting region 3155 as appropriate. The “confirm” button 3251 is operated by the user to confirm each input described above. The “collective settings” button 3252 is operated by the user to apply the setting values relating to the inspection exclusion area to the print medium or to the entire job to be executed. The operation of the “collective settings” button 3252 will be described in detail later. The “complete settings” button 3253 is operated by the user to complete the input made on the inspection area setting screen 3011. The “cancel settings” button 3254 is operated by the user to cancel the input made on the inspection area setting screen 3011.

When there are two or more inspection exclusion areas to be set, the user may repeat the following operations to set the horizontal position and the vertical position for each inspection exclusion area. The user first operates the “confirm” button 3251 to confirm each input setting value. Then, the user inputs desired values to the horizontal position setting region 3154 and the vertical position setting region 3155 and operates the “confirm” button 3251 again. In this case, the image forming apparatus 3 temporarily stores the input setting values in a predetermined area of the storage unit 3000. For example, in response to the user operating the “confirm” button 3251, the image forming apparatus 3 temporarily stores the desired values input by the user just before the “confirm” button 3251 is operated. Repeating this operation temporarily stores the input desired values that define each inspection exclusion area.

### Example of Screen Display

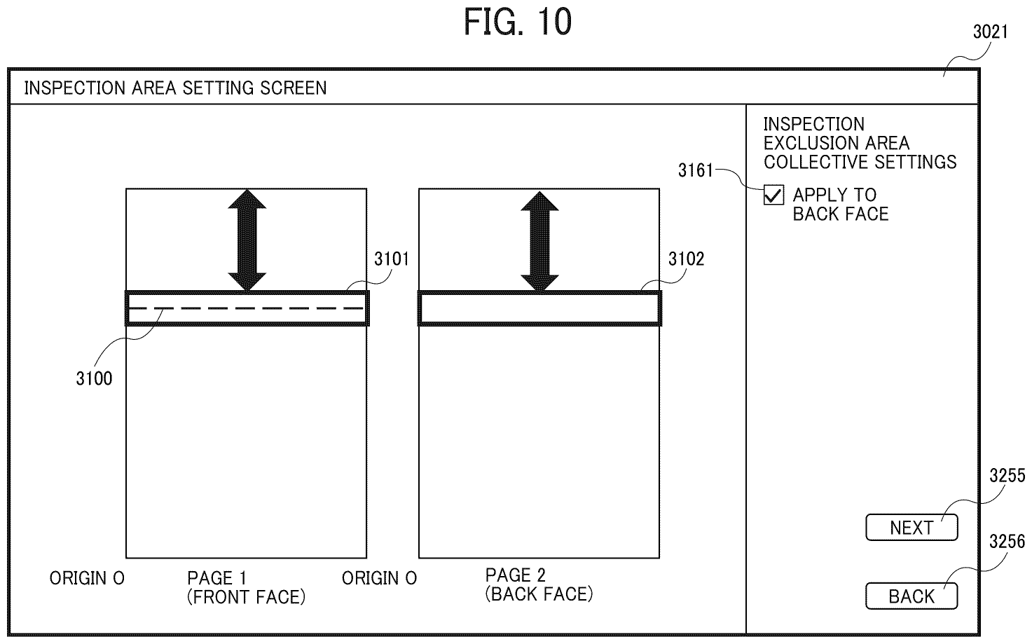

FIG. 10 is a view illustrating an example of an inspection area setting screen displayed on the image forming apparatus 3 when the setting values are to be applied to the back face of the print medium. In response to the user operating the “collective settings” button 3252 with the “inspection exclusion area” selected with the pull-down key in the area type selection region 3151 of the inspection area setting screen 3011 illustrated in FIG. 9, the display control unit 34 switches the screen from the inspection area setting screen 3011 to an inspection area setting screen 3021 illustrated in FIG. 10. The inspection area setting screen 3021 illustrated in FIG. 10 is an example of a setting screen displayed when the setting values are to be applied to the back face.

The inspection area setting screen 3021 displays a thumbnail image of a page 1 (front face) and a thumbnail image of a page 2 (back face) side by side with respect to the origin O. The thumbnail image of the page 1 and the thumbnail image of the page 2 respectively depict a rectangle 3101 and a rectangle 3102 such that the rectangle 3101 and the rectangle 3102 surround a perforation 3100 (dotted line portion) formed on the print medium. The perforation 3100 is an example of the predetermined processing. The rectangle 3101 on the front face and the rectangle 3102 on the back face are depicted as the inspection exclusion areas calculated and set so as to correspond to the size of the print medium input by the user.

In this state, in response to the user checking a check box 3161 for “apply to back face” in the “inspection exclusion area collective settings,” the inspection exclusion area depicted in each thumbnail image is set. In this state, in a case where the user operates a “next” button 3255, the display control unit 34 displays an inspection area setting screen 3031 described later. Operating a “back” button 3256 allows the user to return to the inspection area setting screen 3011.

### Example of Screen Display

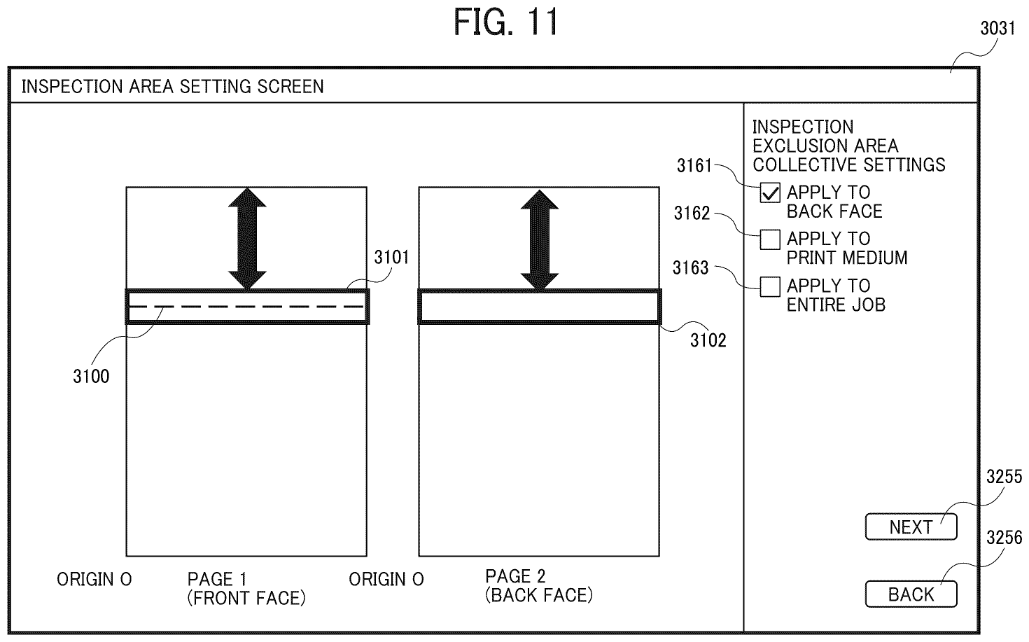

FIG. 11 is a view illustrating an example of an inspection area setting screen displayed on the image forming apparatus 3 when the setting values are to be applied to at least one of the back face, the print medium, and the entire job. In FIG. 11, the display control unit 34 displays the inspection area setting screen 3031. The inspection area setting screen 3031 displays a check box 3162 for “apply to print medium” and a check box 3163 for “apply to entire job,” in addition to the items displayed on the inspection area setting screen 3021 illustrated in FIG. 10. In one example, each time the user operates the “collective settings” button 3252, the display control unit 34 may switch (toggle) the display between the inspection area setting screen 3021 and the inspection area setting screen 3031.

### Example of Screen Display

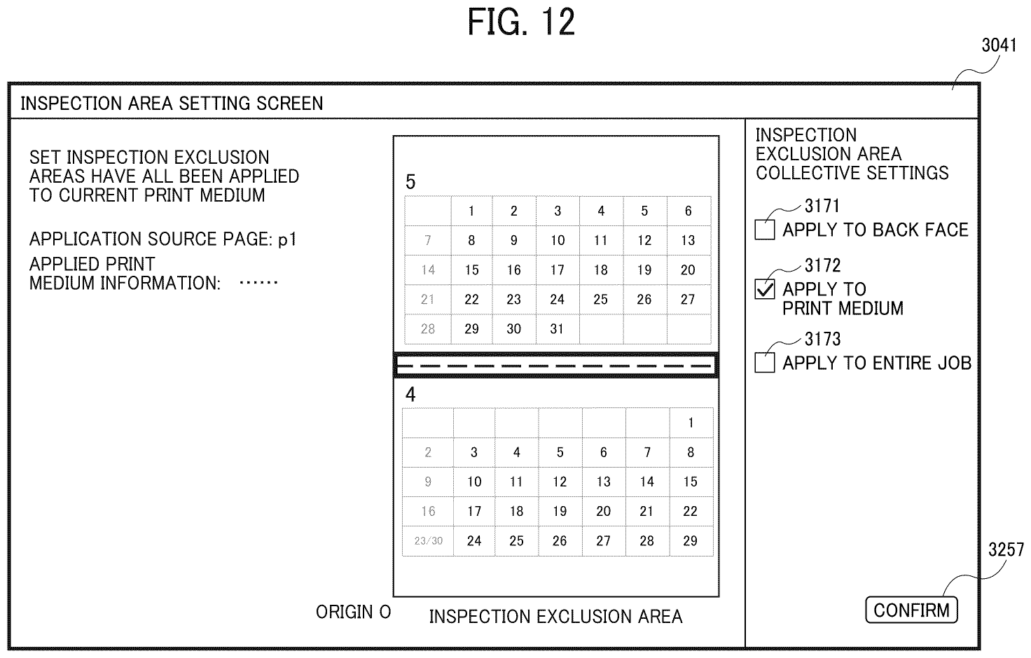

FIG. 12 is a view illustrating an example of an inspection area setting screen displayed on the image forming apparatus 3 when the setting values are to be applied to the print medium. As illustrated in FIG. 12, the display control unit 34 displays an inspection area setting screen 3041, which includes a thumbnail image of the inspection area including the inspection exclusion area and a message indicating the application of the setting values to the print medium. The display control unit 34 displays the inspection area setting screen 3041 in response to the user operating the “next” button 3255 with the check box 3162 for “apply to print medium,” which is displayed on the inspection area setting screen 3031 illustrated in FIG. 11, checked. In response to the user confirming on the inspection area setting screen 3041 that a check box 3172 for “apply to print medium” is checked, and operating a “confirm” button 3257, the setting values including the inspection exclusion area input on the inspection area setting screen 3011 illustrated in FIG. 9 are applied to the print medium. The image inspection apparatus 4 described later performs this application to the print medium.

### Example of Screen Display

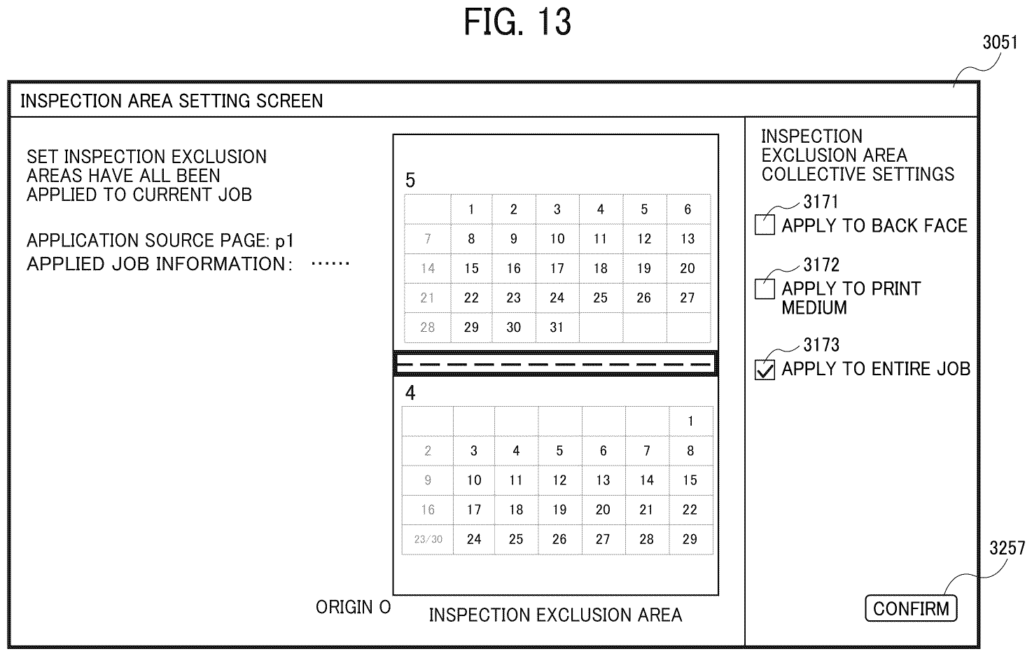

FIG. 13 is a view illustrating an example of an inspection area setting screen displayed on the image forming apparatus 3 when the setting values are to be applied to the entire job. In FIG. 13, the display control unit 34 displays an inspection area setting screen 3051, which includes a thumbnail image of the inspection area including the inspection exclusion area and a message indicating the application of the setting values to the entire job. The display control unit 34 displays the inspection area setting screen 3051 in response to the user operating the “next” button 3255 with the check box 3163 for “apply to entire job,” which is displayed on the inspection area setting screen 3031 illustrated in FIG. 11, checked. In response to the user confirming on the inspection area setting screen 3051 that a check box 3173 for “apply to entire job” is checked, and operating the “confirm” button 3257, the setting values including the inspection exclusion area input on the inspection area setting screen 3011 illustrated in FIG. 9 are applied to the entire job to be executed. The image inspection apparatus 4 described later performs this application to the entire job.

Referring back to FIG. 8, in step S12, the operation acceptance unit 32 accepts the input of various pieces of information. In this step, the operation acceptance unit 32 accepts various pieces of desired information input by the user on each of the inspection area setting screens illustrated in FIGS. 9 to 13.

In step S13, the transmission and reception unit 31 transmits a various information setting request to the image inspection apparatus 4. The transmission and reception unit 41 of the image inspection apparatus 4 receives the various information setting request transmitted from the image forming apparatus 3. The various information setting request includes inspection exclusion area information (including information regarding the size of the print medium, processing type, and various setting values) to be stored and managed in the inspection exclusion area management DB 4002 (see FIG. 7).

In step S14, the image comparison and inspection unit 400 of the image inspection apparatus 4 (namely, the calculation and setting unit 46) sets an inspection exclusion area. The calculation and setting unit 46 stores, via the storing and reading unit 49, the inspection exclusion area information such as the size of the print medium, the processing type, and various setting values received in step S13 in the corresponding items of the inspection exclusion area management DB 4002 (see FIG. 7). The storing and reading unit 49 may also acquire the print medium ID of the print medium to be used in the job to be executed, and receive and store, from the image forming apparatus 3, initial values corresponding to parameters of a job associated with this print medium ID in the corresponding items of the job information management DB 4001.

An example of detailed settings of the inspection exclusion area is described herein. As an example, consider a case where an image formed on an A4-portrait print medium (210 mm×297 mm) subjected to perforation is to be inspected. The image comparison and inspection unit 400 (namely, the calculation and setting unit 46) of the image inspection apparatus 4 searches the inspection exclusion area management DB 4002 using the print medium ID as a search key or using the size of the print medium and processing type as search keys via the storing and reading unit 49, and reads the corresponding non-detection widths (values of horizontal and vertical widths) and non-detection positions (values of horizontal and vertical positions). Subsequently, the calculation and setting unit 46 calculates an inspection exclusion area on the second face (back face) of the print medium from the read values. In one example, the inspection exclusion area on the second face (back face) of the print medium is calculated as described below.

For example, the calculation and setting unit 46 refers to the relative positions of the predetermined processing on the first face and the second face illustrated in FIG. 2 and the setting values for the non-detection area illustrated in FIG. 7, and calculates and sets a second inspection exclusion area based on the input information (inspection exclusion area information, i.e., setting value information of the non-detection area) and the length information (the size of the print medium) indicating the length of the print medium along the conveyance direction of the print medium. In other words, the calculation and setting unit 46 sets the inspection exclusion area on the second face (back face) of the print medium based on the input information that has been input for the first face (front face) of the print medium. The calculation and setting unit 46 stores each calculated value in a predetermined area of the storage unit 4000. The calculation and setting unit 46 may store and manage each calculated value as a new item in the inspection exclusion area management DB 4002 illustrated in FIG. 7.

When perforation described above is formed as the predetermined processing, the setting values relating to the inspection exclusion positions (non-detection horizontal and vertical positions) on the second face of the print medium in the sub-scanning direction do not differ from the setting values relating to the inspection exclusion positions (non-detection horizontal and vertical positions) on the first face of the print medium in the sub-scanning direction. However, when two holes are formed along the conveyance direction of the print medium as the predetermined processing and the distance of one of the holes from the bisector of the print medium in the sub-scanning direction differs from the distance of the other hole from the bisector in the sub-scanning direction (the two holes are formed asymmetrically with respect to the bisector), the calculation and setting unit 46 changes the setting values relating to the inspection exclusion positions (non-detection horizontal and vertical positions) on the second face (back face) of the print medium. In this case, how to change the setting values is as described above.

In step S15, the transmission and reception unit 41 transmits a various information setting response to the image forming apparatus 3 as a response to the various information setting request received in step S13. The transmission and reception unit 31 of the image forming apparatus 3 receives the various information setting response transmitted from the image inspection apparatus 4.

In step S16, the transmission and reception unit 31 of the image forming apparatus 3 transmits a setting request to the DFE 5. The transmission and reception unit 51 of the DFE 5 then receives the setting request transmitted from the image forming apparatus 3. The setting request includes image data to be used for image formation.

In step S17, the acquisition processing unit 53 of the DFE 5 acquires the image data. Specifically, the acquisition processing unit 53 acquires the image data received via the transmission and reception unit 51.

In step S18, the acquisition processing unit 53 performs a RIP process. Specifically, the acquisition processing unit 53 uses the acquired image data to generate a RIP image converted into a form suitable for printing. The acquisition processing unit 53 may employ any desired technique to generate and acquire RIP image data through the RIP process.

In step S19, the generation unit 57 generates job data. Specifically, the generation unit 57 generates job data based on the RIP image processed in step S18. The job data includes RIP image data and print medium information including the type of print medium.

In step S20, the operation acceptance unit 52 accepts an image formation instruction. The operation acceptance unit 52 may employ any desired technique to accept the image formation instruction.

In step S21, the transmission and reception unit 51 transmits a setting response to the image forming apparatus 3 as a response to the setting request received in step S16. The transmission and reception unit 31 of the image forming apparatus 3 then receives the setting response transmitted from the DFE 5. The setting response may include, for example, a message indicating the response to the setting request and flag information.

The sequence diagram illustrated in FIG. 8 is merely an example, and various processes described above are not limited thereto.

In the image inspection system 2 according to the present embodiment, for example, the image forming apparatus 3 and the image inspection apparatus 4 may perform steps S13 and S15 via one or more other apparatuses. For example, the image forming apparatus 3 and the image inspection apparatus 4 may transmit and receive each information (data) to and from each other via one or more other apparatuses. This configuration may also be applied when the image forming apparatus 3 and the image inspection apparatus 4 perform additional steps.

In the image inspection system 2 according to the present embodiment, for example, the DFE 5 and the image forming apparatus 3 may perform the processes of steps S16 and S21 via one or more other apparatuses. For example, the DFE 5 and the image forming apparatus 3 may transmit and receive each information (data) to and from each other via one or more other apparatuses. This configuration may also be applied when the DFE 5 and the image forming apparatus 3 perform additional steps.

### Image Inspection Process

An image inspection process is described herein. FIG. 14 is a sequence diagram illustrating an example of the image inspection process in the image management system 1. As illustrated in FIG. 14, in step S31, the transmission and reception unit 51 of the DFE 5 transmits an image forming instruction request to the image forming apparatus 3. The transmission and reception unit 31 of the image forming apparatus 3 then receives the image forming instruction request transmitted from the DFE 5. The image forming instruction request includes command data indicating a job command and RIP image data. In another example, the transmission and reception unit 51 of the DFE 5 may perform the process of step S31 during the process of step S21 in which the transmission and reception unit 51 transmits the setting response.

In step S32, the execution processing unit 38 of the image forming apparatus 3 performs the image forming process together with the generation and formation unit 37.

In step S33, the transmission and reception unit 31 transmits an image inspection request to the image inspection apparatus 4. The transmission and reception unit 41 of the image inspection apparatus 4 then receives the image inspection request transmitted from the image forming apparatus 3. The image inspection request includes, for example, RIP image data processed based on an input image and print medium information indicating the type of print medium.

In step S34, the inspection processing unit 48 of the image inspection apparatus 4 performs the image inspection process. Specifically, the inspection processing unit 48 compares images in the inspection area using the image data indicated by the RIP image data and print medium information received in step S33, the image formed on the print medium (printed matter) read by the image forming apparatus 3, the master image generated based on the RIP image, and the inspection exclusion area information corresponding to the print medium stored in a predetermined area of the storage unit 4000. Specifically, the inspection processing unit 48 compares the image formed on the print medium (printed matter) with the master image generated based on the RIP image. As a result of the comparison of the images in the inspection area (e.g., the predetermined area and image), when the inspection processing unit 48 determines that the difference is equal to or greater than or exceeds a predetermined threshold value, the inspection processing unit 48 determines, in cooperation with the determination unit 45, whether or not an abnormality has occurred on the image formed on the print medium.

In step S35, the generation unit 47 generates notification screen data. Specifically, the generation unit 47 generates the notification screen data representing the result of the inspection via the storing and reading unit 49. The generation unit 47 may also store the generated notification screen data in another predetermined area of the storage unit 4000 via the storing and reading unit 49.

In step S36, the transmission and reception unit 41 transmits an image inspection response to the image forming apparatus 3 as a response to the image inspection request received in step S33. The transmission and reception unit 31 of the image forming apparatus 3 then receives the image inspection response transmitted from the image inspection apparatus 4. The image inspection response includes the notification screen data generated in step S35.

In step S37, the display control unit 34 of the image forming apparatus 3 displays a notification screen. Specifically, the display control unit 34 displays the notification screen relating to the notification screen data received in step S36 on the panel display 340a.

### Example of Screen Display

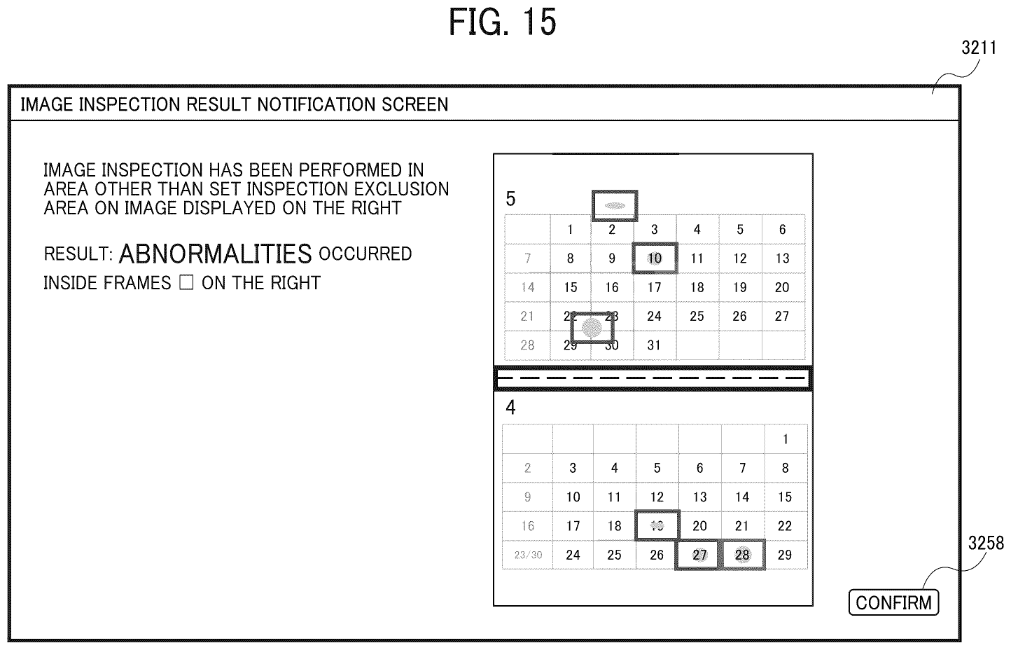

FIG. 15 is a view illustrating an example of an image inspection result notification screen displayed on the image forming apparatus 3. As illustrated in FIG. 15, the display control unit 34 displays an image inspection result notification screen 3211 on the panel display 340a, which is included in the operation panel 340 of the image forming apparatus 3. The image inspection result notification screen 3211 displays a message indicating that one or more abnormalities have been found as the result of the inspection, a thumbnail image of an image formed on the print medium subjected to the inspection, and a “confirm” button 3258. On the thumbnail image of the image formed on at least one of the first face and the second face of the print medium on which the abnormalities have been found, objects (e.g., circular dots) indicating the abnormalities and rectangles surrounding the objects are displayed. This allows the user to simultaneously check the result of the inspection performed on the print medium, the locations where the abnormalities have occurred, and the objects indicating the abnormalities. In one example, in response to the user operating the “confirm” button 3258, another screen relating to the result of the inspection may appear.

Referring back to FIG. 14, the transmission and reception unit 31 of the image forming apparatus 3 may transmit an image inspection response to the DFE 5. The transmission and reception unit 51 of the DFE 5 then receives the image inspection response transmitted from the image forming apparatus 3. The image inspection response may include the notification screen data received by the image forming apparatus 3 in step S36.

Subsequently, the display control unit 54 of the DFE 5 may display the notification screen on the display 507. In one example, the display control unit 54 of the DFE 5 may display, on the display 507, the notification screen relating to the notification screen data transmitted from the image forming apparatus 3.

The sequence diagram illustrated in FIG. 14 is merely an example, and the image inspection process described above is not limited thereto.

As described above, according to the present embodiment, in step S13 of FIG. 8, the image inspection apparatus 4 receives, for the first inspection area within which the first image formed on the first face of the print medium is to be inspected, the inspection exclusion area information relating to the first inspection exclusion area including the predetermined processing performed on the print medium. In step S14 of FIG. 8, the image inspection apparatus 4 calculates and sets the inspection exclusion area on the second face of the print medium based on the received inspection exclusion area information, which is information regarding setting values of the non-detection area, and the length information (the size of the print medium) indicating the length of the print medium along the conveyance direction of the print medium. This configuration allows the image inspection apparatus 4 to set the inspection exclusion areas for the first face and the second face at a time so as to correspond to the position at which the predetermined processing has been performed on the print medium, even though the image inspection apparatus 4 inspects each of the first image formed on the first face that has been read by the single device at the first timing and the second image formed on the second face that has been read by the single device at the second timing later than the first timing with the print medium reversed along the conveyance direction of the print medium.

Each of the functions of the described embodiments can be implemented by one or more processing circuits or circuitry. As used herein, the term “processing circuit or circuitry” includes processors programmed to implement each function by software, such as a processor implemented by an electronic circuit, and devices designed to implement the functions described above, such as an application specific integrated circuit (ASIC), a digital signal processor (DSP), a field programmable gate array (FPGA), System on a chip (SOC), a graphics processing unit (GPU), and existing circuit modules.

In the embodiment described above, the image inspection system 2 may set an inspection exclusion area using machine learning which is learning using artificial intelligence (AI). In this case, for example, the image inspection apparatus 4 manages setting values of an inspection exclusion area in association with the type of print medium. The setting values of the inspection exclusion area correspond to the type of predetermined processing input into the image forming apparatus 3. In this state, when a new job is executed with the predetermined processing performed on the print medium, the image inspection apparatus 4 may acquire, from the image forming apparatus 3, image information (area setting information) acquired by reading, in advance, the print medium on which an image has been formed and on which the predetermined processing has been performed. After that, the image inspection apparatus 4 may use machine learning to automatically set an inspection exclusion area based on the acquired image information. By performing the processes in this manner, the image inspection system 2 may allow the user to omit the input of the inspection exclusion area.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Aspects of the present disclosure are, for example, as follows.

### First Aspect

In a first aspect, the image inspection apparatus 4 (an example of the image inspection apparatus) inspects each of an image formed on a first face of a print medium and an image formed on a second face of the print medium. Specifically, the image inspection apparatus 4 inspects each of the image formed on the first face that has been read by a single device at a first timing and the image formed on the second face that has been read by the single device at a second timing later than the first timing with the print medium reversed along a conveyance direction of the print medium. The image inspection apparatus 4 includes the transmission and reception unit 41 (an example of the first reception means) and the calculation and setting unit 46 (an example of the calculation means and an example of the setting means). The transmission and reception unit 41 receives, for a first inspection area within which a first image formed on the first face is to be inspected, input information relating to a first inspection exclusion area including predetermined processing performed on the print medium. The calculation and setting unit 46 sets, based on the received input information, a second inspection exclusion area that is not included in a second inspection area within which a second image formed on the second face is to be inspected.

### Second Aspect

In a second aspect, the transmission and reception unit 41 of the image inspection apparatus 4 according to the first aspect receives, as the input information relating to the first inspection exclusion area, a width of the first inspection exclusion area including the predetermined processing performed on the print medium and a plurality of coordinates indicating the width.

### Third Aspect

In a third aspect, the calculation and setting unit 46 of the image inspection apparatus 4 according to the first aspect or the second aspect sets the second inspection exclusion area based on the input information and length information indicating a length of the print medium along the conveyance direction.

### Fourth Aspect

In a fourth aspect, the calculation and setting unit 46 of the image inspection apparatus 4 according to any one of the first aspect to the third aspect sets the second inspection exclusion area to one of the print medium and a predetermined entire job forming the print medium, in response to an operation of collectively setting the second inspection exclusion area.

### Fifth Aspect

In a fifth aspect, the predetermined processing performed on the print medium according to any one of the first aspect to the fourth aspect includes at least one of perforation, hole formation, corner rounding, and embossing formed on the print medium.

### Sixth Aspect

In a sixth aspect, the image inspection apparatus 4 according to any one of the first aspect to the fifth aspect includes the inspection processing unit 48 (an example of the inspection means), which inspects the first image and the second image formed on the print medium.

### Seventh Aspect

The image inspection system 2 (an example of the image inspection system) according to a seventh aspect includes the image forming apparatus 3 (an example of the image forming apparatus) and the image inspection apparatus 4 (an example of the image inspection apparatus). The image forming apparatus 3 forms an image on the print medium based on input image data and performs the predetermined processing on the print medium. The image inspection apparatus 4 inspects each of an image formed on the first face that has been read by the single device at the first timing and an image formed on the second face that has been read by the single device at the second timing later than the first timing with the print medium reversed along the conveyance direction of the print medium. The image forming apparatus 3 includes the operation acceptance unit 32 (an example of the reception means) and the transmission and reception unit 31 (an example of the first transmission means). The operation acceptance unit 32 accepts, for the first inspection area within which the first image formed on the first face is to be inspected, an input of the input information relating to the first inspection exclusion area including the predetermined processing performed on the print medium. The transmission and reception unit 31 transmits the accepted input information to the image inspection apparatus 4. The image inspection apparatus 4 includes the transmission and reception unit 41 (an example of the first reception means) and the calculation and setting unit 46 (an example of the calculation means and an example of the setting means). The transmission and reception unit 41 receives the input information. The calculation and setting unit 46 sets, based on the received input information, the second inspection exclusion area that is not included in the second inspection area within which the second image formed on the second face is to be inspected.

### Eighth Aspect

In an eighth aspect, the image forming apparatus 3 according to the seventh aspect further includes the transmission and reception unit 31 (an example of the second reception means) and the display control unit 34 (an example of the display control means). The transmission and reception unit 31 receives inspection screen data representing a result of inspection relating to at least one of the first image and the second image inspected by the image inspection apparatus 4. The display control unit 34 displays the received inspection screen data on the panel display 340a (an example of the display means).

### Ninth Aspect

In a ninth aspect, an image inspection method is performed by the image inspection apparatus 4 (an example of the image inspection apparatus), which inspects each of an image formed on a first face of a print medium and an image formed on a second face of the print medium. The image inspection apparatus 4 inspects each of the image formed on the first face that has been read by a single device at a first timing and the image formed on the second face that has been read by the single device at a second timing later than the first timing with the print medium reversed along a conveyance direction of the print medium. The image inspection method includes a reception step of receiving, for a first inspection area within which a first image formed on the first face of the print medium is to be inspected, input information relating to a first inspection exclusion area including predetermined processing performed on the print medium, and a setting step of setting, based on the received input information, a second inspection exclusion area that is not included in a second inspection area within which a second image formed on the second face of the print medium is to be inspected.

### Tenth Aspect

In a tenth aspect, a program causes the image inspection apparatus 4 (an example of the image inspection apparatus), which inspects each of an image formed on a first face of a print medium and an image formed on a second face of the print medium, to perform an image inspection method. The image inspection apparatus 4 inspects each of the image formed on the first face that has been read by a single device at a first timing and the image formed on the second face that has been read by the single device at a second timing later than the first timing with the print medium reversed along a conveyance direction of the print medium. The image inspection method includes a reception step of receiving, for a first inspection area within which a first image formed on the first face of the print medium is to be inspected, input information relating to a first inspection exclusion area including predetermined processing performed on the print medium, and a setting step of setting, based on the received input information, a second inspection exclusion area that is not included in a second inspection area within which a second image formed on the second face of the print medium is to be inspected.

According to the one or more aspects described above, the image inspection apparatus 4 sets the inspection exclusion areas for the first face and the second face of the print medium at a time so as to correspond to the position at which the predetermined processing has been performed on the print medium, even though the image inspection apparatus 4 inspects each of the first image formed on the first face that has been read by the single device at the first timing and the second image formed on the second face that has been read by the single device at a second timing later than the first timing with the print medium reversed along the conveyance direction of the print medium.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

1. An image inspection apparatus comprising circuitry configured to:
acquire a first image and a second image,
the first image being generated by reading, at a first timing, an image formed on a first face of a print medium,
the second image being generated by reading, at a second timing later than the first timing, an image formed on a second face of the print medium reversed along a conveyance direction of the print medium;
receive, for a first inspection area within which the first image is to be inspected, input information relating to a first inspection exclusion area including predetermined processing performed on the print medium; and
set, based on the received input information, a second inspection exclusion area that is not included in a second inspection area within which the second image is to be inspected.

2. The image inspection apparatus according to claim 1, wherein the input information relating to the first inspection exclusion area includes a width of the first inspection exclusion area including the predetermined processing performed on the print medium and a plurality of coordinates indicating the width.

3. The image inspection apparatus according to claim 1, wherein the circuitry is configured to set the second inspection exclusion area based on the input information and length information indicating a length of the print medium along the conveyance direction.

4. The image inspection apparatus according to claim 1, wherein the circuitry is configured to, in response to an operation of collectively setting the second inspection exclusion area, set the second inspection exclusion area to one of the print medium and a predetermined entire job forming the print medium.

5. The image inspection apparatus according to claim 1, wherein the predetermined processing includes at least one of perforation, hole formation, corner rounding, or embossing formed on the print medium.

6. The image inspection apparatus according to claim 1, wherein the circuitry is configured to inspect the first image and the second image.

7. An image inspection system comprising:
an image forming apparatus; and
the image inspection apparatus according to claim 1,
the image forming apparatus including:
an image forming engine to form an image on the print medium based on input image data;
image forming device circuitry configured to perform control to perform the predetermined processing on the print medium; and
an operation device to accept, for the first inspection area within which the first image formed on the first face is to be inspected, an input of the input information relating to the first inspection exclusion area including the predetermined processing performed on the print medium,
the image forming device circuitry being configured to transmit the accepted input information to the image inspection apparatus,
the circuitry of the image inspection apparatus being configured to:
receive the input information; and
set, based on the received input information, the second inspection exclusion area that is not included in the second inspection area within which the second image formed on the second face is to be inspected.

8. The image inspection system according to claim 7, wherein the image forming device circuitry of the image forming apparatus is configured to:
receive inspection screen data representing a result of inspection relating to at least one of the first image or the second image inspected by the image inspection apparatus; and
display the received inspection screen data on a display.

9. An image inspection method comprising:
acquiring a first image and a second image,
the first image being generated by reading, at a first timing, an image formed on a first face of a print medium,
the second image being generated by reading, at a second timing later than the first timing, an image formed on a second face of the print medium reversed along a conveyance direction of the print medium;
receiving, for a first inspection area within which the first image is to be inspected, input information relating to a first inspection exclusion area including predetermined processing performed on the print medium; and
setting, based on the received input information, a second inspection exclusion area that is not included in a second inspection area within which the second image is to be inspected.

10. A non-transitory recording medium storing a plurality of instructions which, when executed by one or more processors, causes the processors to perform an image inspection method, the method comprising:
acquiring a first image and a second image,
the first image being generated by reading, at a first timing, an image formed on a first face of a print medium,
the second image being generated by reading, at a second timing later than the first timing, an image formed on a second face of the print medium reversed along a conveyance direction of the print medium;
receiving, for a first inspection area within which the first image is to be inspected, input information relating to a first inspection exclusion area including predetermined processing performed on the print medium; and
setting, based on the received input information, a second inspection exclusion area that is not included in a second inspection area within which the second image is to be inspected.
